(19) United States
(12) Patent Application Publication
(10) Pub. No.: US 2025/0093790 A1
(43) Pub. Date: Mar. 20, 2025

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventor: Masahiro IWASAKI, Kanagawa (JP)

(73) Assignee: FUJIFILM Business Innovation Corp., Tokyo (JP)

(21) Appl. No.: 18/588,796

(22) Filed: Feb. 27, 2024

(30) Foreign Application Priority Data
Sep. 20, 2023 (JP) 2023-153894

(51) Int. Cl. G03G 5/147; G03G 5/05; G03G 5/14

(52) U.S. Cl. CPC G03G 5/14708; G03G 5/056; G03G 5/144; G03G 2215/00957; G03G 2215/00962; G03G 2221/183

(57) ABSTRACT

An electrophotographic photoreceptor includes a conductive substrate, an undercoat layer that is provided on the conductive substrate, a charge generation layer that is provided on the undercoat layer, a charge transport layer that is provided on the charge generation layer and contains a polyester resin (1) having a dicarboxylic acid unit (A) represented by Formula (A) and a diol unit (B) represented by Formula (B) and a charge transport material, and a surface protective layer that is provided on the charge transport layer and is a cured film with a composition containing a curing agent which contains at least one of a guanamine compound or a melamine compound, and at least one reactive group-containing charge transport material having at least one substituent selected from the group consisting of —OH, —OCH₃, —NH₂, —SH, and —COOH,

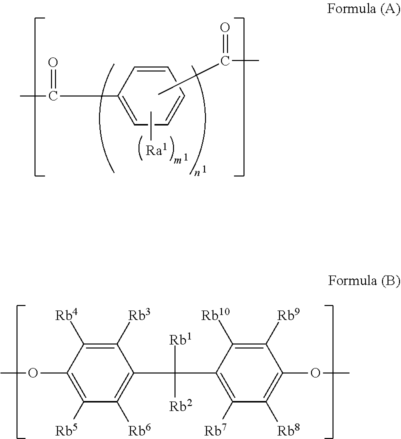

in Formula (A), n¹ represents 1, 2, or 3, n¹ pieces of m¹'s each independently represent 0, 1, 2, 3, or 4, m¹ pieces of Ra¹'s each independently represent an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

### CROSS-REFERENCE TO RELATED APPLICATIONS

This application is based on and claims priority under 35 USC 119 from Japanese Patent Application No. 2023-153894 filed Sep. 20, 2023.

### BACKGROUND

### (i) Technical Field

The present invention relates to an electrophotographic photoreceptor, a process cartridge, and an image forming apparatus.

### (ii) Related Art

JP2004-205542A discloses “an electrophotographic photoreceptor including a conductive support and a photosensitive layer provided on the conductive support, in which an electrostatic latent image is formed by exposing the photosensitive layer to be uniformly charged, to light according to image information, and a surface free energy (y) of a surface of the photosensitive layer is 20 mN/m or greater and 35 mN/m or less”.

JP2007-057603A discloses “an electrophotographic photoreceptor including a conductive support and a photosensitive layer disposed on the conductive support, in which the photosensitive layer includes a first layer formed by heating and curing a first thermosetting resin composition that contains a phenol resin, and a second layer formed by heating and curing a second thermosetting resin composition that is disposed adjacent to the first layer and contains at least one modified phenol resin selected from the group consisting of an alkyl-modified phenol resin, an acrylic modified phenol resin, an ester-modified phenol resin, an amide-modified phenol resin, and a urethane-modified phenol resin”.

JP2009-037229A discloses “an electrophotographic photoreceptor including at least a photosensitive layer on a conductive support, in which the photosensitive layer contains a resin having a polysiloxane component and a polyarylate resin”.

JP2010-231086A discloses “an image forming apparatus including an electrophotographic photoreceptor that includes a photosensitive layer and a surface protective layer in this order on a conductive substrate, charging means that charges the electrophotographic photoreceptor, electrostatic latent image forming means that forms an electrostatic latent image on the charged electrophotographic photoreceptor, developing means that develops the electrostatic latent image formed on the electrophotographic photoreceptor with a toner to form a toner image, transfer means that transfers the toner image to a medium to be transferred, and residual toner removal means that removes the toner remaining on the electrophotographic photoreceptor after the transfer of the toner image, in which the surface protective layer of the electrophotographic photoreceptor has a surface free energy of 10 mN/m or greater and 30 mN/m or less, the toner of the developing means is a toner containing silica, and the toner removal means includes a blade member including a base layer and an edge layer which has a type A durometer hardness of HsA75 or greater and HsA90 or less at 23° C. and has a higher hardness than the hardness of the base layer”.

JP2013-195710A discloses “an electrophotographic photoreceptor including a conductive substrate, a photosensitive layer provided on the conductive substrate, and a surface protective layer that is a surface protective layer provided on the photosensitive layer, is formed of a cured film with a composition containing a charge transport material and at least one selected from a compound having a guanamine structure and a compound having a melamine structure, and has a surface free energy of 45 mN/m or greater and 95 mN/m or less”.

JP2017-167423A discloses “an electrophotographic photoreceptor including a conductive substrate and a photosensitive layer that is a single layer type photosensitive layer provided on the conductive substrate, containing a binder resin, a charge generation material, a positive hole transport material, and an electron transport material represented by a specific general formula, and having a surface free energy of 24 mN/m or greater and 30 mN/m or less, which is obtained by measuring a side of an outer peripheral surface of the photosensitive layer”.

JP2022-181413A discloses “an electrophotographic photoreceptor including a conductive substrate and a photosensitive layer, in which the photosensitive layer contains a charge generation agent, a positive hole transport agent, a first resin, and a second resin different from the first resin, the first resin and the second resin are contained in the same layer, a content of the first resin is 50% or greater and less than 100% with respect to the total mass of the first resin and the second resin, the first resin is a polyarylate resin, the polyarylate resin has repeating units each represented by Formulae (1), (2), (3), and (4), and a content of the repeating unit represented by Formula (3) is greater than 0% and less than 20% with respect to the total amount of the repeating units represented by Formulae (1) and (3)”.

### SUMMARY

In the related art, in a lamination type electrophotographic photoreceptor including a surface protective layer that is a cured film with a composition containing a curing agent which contains at least one of a guanamine compound or a melamine compound and at least one reactive group-containing charge transport material having at least one substituent selected from the group consisting of —OH, —OCH₃, —NH₂, —SH, and —COOH, since the adhesiveness of the interface between the surface protective layer and the charge transport layer is low, the surface protective layer is peeled off or floated from the charge transport layer in a case where the thickness of the surface protective layer is reduced. Aspects of non-limiting embodiments of the present disclosure relate to an electrophotographic photoreceptor that suppresses a surface protective layer from being peeled off or being floated from a charge transport layer in a case where the thickness of the surface protective layer is reduced as compared with a case where the charge transport layer contains a polycarbonate resin without containing the polyester resin (1) in the lamination type electrophotographic photoreceptor including the surface protective layer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object includes the following aspects.

According to an aspect of the present disclosure, there is provided an electrophotographic photoreceptor including: a conductive substrate; an undercoat layer that is provided on the conductive substrate; a charge generation layer that is provided on the undercoat layer; a charge transport layer that is provided on the charge generation layer and contains a polyester resin (1) having a dicarboxylic acid unit (A) represented by Formula (A) and a diol unit (B) represented by Formula (B) and a charge transport material; and a surface protective layer that is provided on the charge transport layer and is a cured film with a composition containing a curing agent which contains at least one of a guanamine compound or a melamine compound, and at least one reactive group-containing charge transport material having at least one substituent selected from the group consisting of —OH, —OCH₃, —NH₂, —SH, and —COOH,

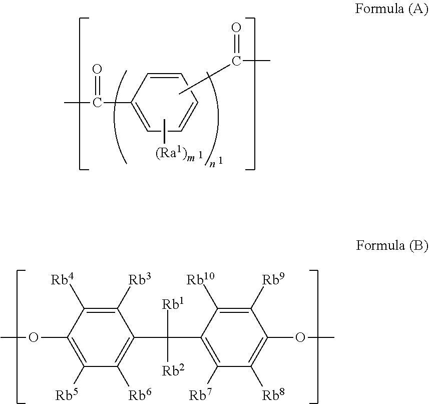

(in Formula (A), n¹ represents 1, 2, or 3, n¹ pieces of m¹'s each independently represent 0, 1, 2, 3, or 4, m¹ pieces of Ra¹'s each independently represent an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.)

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment:

FIG. 2 is a schematic configuration view showing an example of an image forming apparatus according to the present exemplary embodiment; and

FIG. 3 is a schematic configuration view showing another example of the image forming apparatus according to the present exemplary embodiment.

### DETAILED DESCRIPTION

Hereinafter, exemplary embodiments of the present disclosure will be described. The following descriptions and examples merely illustrate the exemplary embodiments, and do not limit the scope of the exemplary embodiments.

In the present disclosure, a numerical range shown using “to” indicates a range including numerical values described before and after “to” as a minimum value and a maximum value.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in examples.

In the present disclosure, the meaning of the term “step” includes not only an independent step but also a step whose intended purpose is achieved even in a case where the step is not clearly distinguished from other steps.

In the present disclosure, in a case where an exemplary embodiment is described with reference to drawings, the configuration of the exemplary embodiment is not limited to the configuration shown in the drawings. In addition, the sizes of members in each drawing are conceptual and the relative relation in the sizes between the members is not limited thereto.

In the present disclosure, each component may include a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

In the present disclosure, each component may include a plurality of kinds of particles corresponding to each component. In a case where a plurality of kinds of particles corresponding to each component are present in a composition, the particle diameter of each component indicates the value of a mixture of the plurality of kinds of particles present in the composition, unless otherwise specified.

In the present disclosure, the term “(meth)acryl” may denote any of “acryl” or “methacryl”.

In the present disclosure, an alkyl group is any of linear, branched, or cyclic unless otherwise specified.

### Electrophotographic Photoreceptor

An electrophotographic photoreceptor according to the present exemplary embodiment includes a conductive substrate, an undercoat layer that is provided on the conductive substrate, a charge generation layer that is provided on the undercoat layer, a charge transport layer that is provided on the charge generation layer and contains a polyester resin (1) having a dicarboxylic acid unit (A) represented by Formula (A) and a diol unit (B) represented by Formula (B) and a charge transport material, and a surface protective layer that is provided on the charge transport layer and is a cured film with a composition containing a curing agent which contains at least one of a guanamine compound or a melamine compound, and at least one reactive group-containing charge transport material having at least one substituent selected from the group consisting of —OH, —OCH₃, —NH₂, —SH, and —COOH.

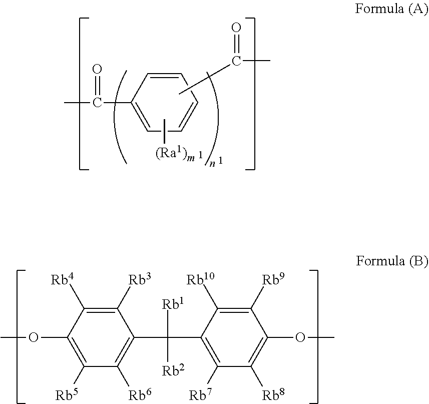

In Formula (A), n¹ represents 1, 2, or 3, n¹ pieces of m¹'s each independently represent 0, 1, 2, 3, or 4, m¹ pieces of Ra¹'s each independently represent an alkyl group having 1 or more and 10 or less carbon atoms, an aryl group having 6 or more and 12 or less carbon atoms, or an alkoxy group having 1 or more and 6 or less carbon atoms.

In Formula (B), Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

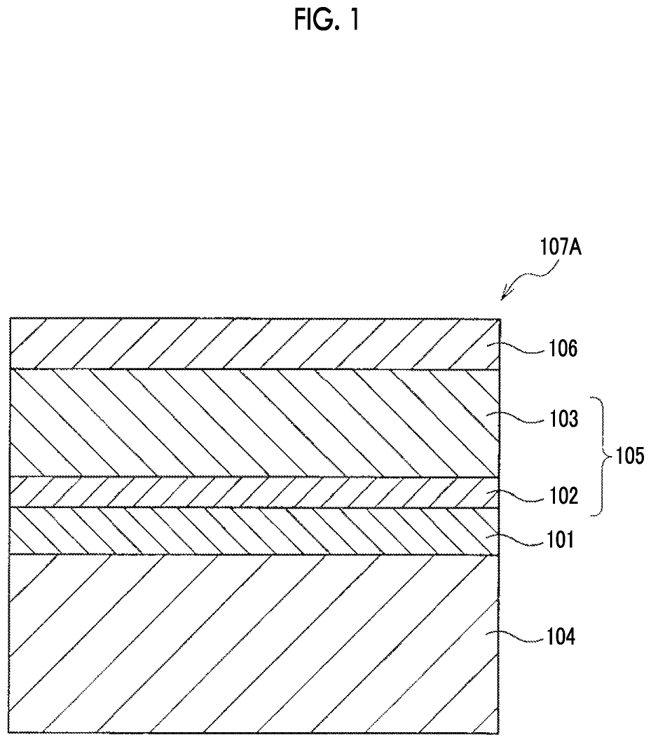

FIG. 1 is a schematic cross-sectional view showing an example of the layer configuration of the electrophotographic photoreceptor according to the present exemplary embodiment. A photoreceptor 107A has a structure in which an undercoat layer 101 is provided on a conductive substrate 104, and a charge generation layer 102, a charge transport layer 103, and a surface protective layer 106 are formed on the undercoat layer 101 in this order. The photoreceptor 107A includes an organic photosensitive layer 105 having functions separated into the charge generation layer 102 and the charge transport layer 103. Although not shown, the photoreceptor 107A may have an interlayer between the conductive substrate 104 and the undercoat layer 101 or between the undercoat layer 101 and the charge generation layer 102.

As a technique for enhancing the abrasion resistance of the photosensitive layer, a technique of using a polyester resin having a rigid skeleton with repeating aromatic rings as a binder resin for a charge transport material has been known. However, in a case where a polyester resin having a rigid skeleton with repeating aromatic rings is used as the binder resin of the charge transport layer, the molecular dispersibility of the charge transport material may be degraded, and as a result, the electrical properties of the photoreceptor do not satisfy the expected value in some cases. Further, in a case where a polyester resin that has a rigid skeleton with repeating aromatic rings having low polarity is used as a binder resin for a charge transport layer and in a case where a surface protective layer containing a reactive group with high polarity is applied to an upper layer, since the coating properties of the surface of the charge transport layer are low and the adhesiveness between the surface protective layer and the charge transport layer after being heated and dried is degraded, the surface protective layer may be peeled off or floated from the charge transport layer. This phenomenon is particularly apparent in a case where the thickness of the surface protective layer is reduced.

Meanwhile, in the electrophotographic photoreceptor according to the present exemplary embodiment, it is possible to suppress the surface protective layer from being peeled off or being floated from the charge transport layer. The mechanism is not necessarily clear, but is assumed as follows.

In the electrophotographic photoreceptor according to the present exemplary embodiment, the charge transport layer contains a polyester resin (1) having a dicarboxylic acid unit (A) represented by Formula (A) and a diol unit (B) represented by Formula (B). Therefore, the surface of the charge transport layer has coating properties. Further, the composition constituting the cured film serving as the surface protective layer contains a curing agent containing at least one of a guanamine compound or a melamine compound, and at least one reactive group-containing charge transport materials having a specific substituent. Therefore, the surface of the surface protective layer also has appropriate coating properties. In this manner, it is considered that the affinity at the interface between the charge transport layer and the surface protective layer is increased, and thus the surface protective layer is suppressed from being peeled off or being floated from the charge transport layer even in a case where the thickness of the surface protective layer is reduced.

### Characteristics of Electrophotographic Photoreceptor

A difference (E_{OCL}−E_{CT}) between the surface free energy E_{OCL} in the surface protective layer and the surface free energy E_{CT} in the charge transport layer is, for example, preferably 6 mN/m or greater and 10 mN/m or less and more preferably 5 mN/m or greater and 9 mN/m or less.

In a case where the difference (E_{OCL}−E_{CT}) is 10 mN/m or less, a decrease in the affinity at the interface between the surface protective layer and the charge transport layer is suppressed, and the adhesiveness of the interface between the surface protective layer and the charge transport layer interface is more excellent.

In a case where the difference (E_{OCL}−E_{CT}) is 6 mN/m or greater, the affinity at the interface between the charge transport layer and the surface protective layer is high, and the adhesiveness of the interface between the surface protective layer and the charge transport layer is more excellent.

The surface free energy E_{OCL} of the surface protective layer is, for example, preferably 38 mN/m or greater and 42 mN/m or less and more preferably 39 mN/m or greater and 41 mN/m or less.

In a case where the surface free energy E_{OCL} is 38 mN/m or greater, a decrease in the interfacial adhesion energy between the surface protective layer and the charge transport layer is likely to be suppressed.

In a case where the surface free energy E_{OCL} is 42 mN/m or less, the adhesiveness of the interface between the surface protective layer and the hydrophobic charge transport layer is excellent, but the activity of the surface protective layer is high and the toner cleaning properties are difficult to degrade.

The surface free energy E_{CT} of the charge transport layer is, for example, preferably 32 mN/m or greater and 35 mN/m or less and more preferably 32 mN/m or greater and 34 mN/m or less.

In a case where the surface free energy E_{CT} is 32 mN/m or greater, the coating properties of the surface protective layer are decreased, and the degradation of the film forming properties of the surface protective layer is likely to be suppressed.

In a case where the surface free energy E_{CT} is 35 mN/m or less, the degradation of the coating properties of the charge generation layer which is the lower layer is suppressed. Further, although the adhesiveness at the interface between the surface protective layer and the charge transport layer is more excellent, the degradation of electrical properties is suppressed.

The surface free energies E_{OCL} and E_{CT} are calculated by measuring the contact angle between water and n-hexadecane with a contact angle meter CA-X (manufactured by Kyowa Surface Science Co., Ltd.) for each film using an OWRK method.

A method of setting the surface free energy E_{CT} to be the above-described range is not particularly limited, and examples thereof include a method of allowing the charge transport layer to contain a predetermined amount of the polyester resin (1) having a dicarboxylic acid unit (A) represented by Formula (A) and a diol unit (B) represented by Formula (B).

A method of setting the surface free energy E_{OCL} to be in the above-described range is not particularly limited, and examples thereof include a method of forming the surface protective layer into a cured film with a composition containing a curing agent which contains at least one of a guanamine compound or a melamine compound and a reactive group-containing charge transport material having at least one substituent of —OH or —OCH₃.

### Polyester Resin (1)

The polyester resin (1) has at least a dicarboxylic acid unit (A) represented by Formula (A) and a diol unit (B) represented by Formula (B). The polyester resin (1) may have other dicarboxylic acid units in addition to the dicarboxylic acid unit (A). The polyester resin (1) may have other diol units in addition to the diol unit (B).

The dicarboxylic acid unit (A) is a constitutional unit represented by Formula (A).

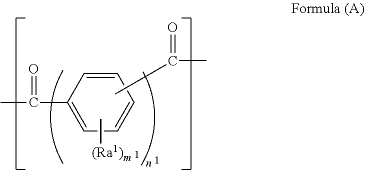

In Formula (A), n¹ represents 1, 2, or 3, n¹ pieces of m¹'s each independently represent 0, 1, 2, 3, or 4, m¹ pieces of Ra¹'s each independently represent an alkyl group having 1 or more and 10 or less carbon atoms, an aryl group having 6 or more and 12 or less carbon atoms, or an alkoxy group having 1 or more and 6 or less carbon atoms.

In Formula (A), n¹ represents 1, 2, or 3 and, for example, preferably 2.

In a case where n¹ represents 2, two benzene rings in Formula (A) may be benzene rings that are the same as or different from each other for m¹ and Ra¹.

In a case where n¹ represents 3, three benzene rings in Formula (A) may be benzene rings that are the same as or different from each other for m¹ and Ra¹.

In a case where n¹ in Formula (A) represents 2 or 3, the linking position between the benzene rings may be any of an ortho position, a meta position, or a para position and, for example, preferably a meta position or a para position.

In Formula (A), m¹ represents 0, 1, 2, 3 or 4, for example, preferably 0, 1, or 2, more preferably 0 or 1, and still more preferably 0.

In a case where m¹ represents 2, two Ra¹'s bonded to the identical benzene ring may be groups that are the same as or different from each other.

In a case where m¹ represents 3, three Ra¹'s bonded to the identical benzene ring may be groups that are the same as or different from each other.

In a case where m¹ represents 4, four Ra¹'s bonded to the identical benzene ring may be groups that are the same as or different from each other.

In Formula (A), the alkyl group having 1 or more and 10 or less carbon atoms may be linear, branched, or cyclic. The number of carbon atoms of the alkyl group is, for example, preferably 1 or more and 6 or less, more preferably 1 or more and 4 or less, and still more preferably 1 or 2.

In Formula (A), the aryl group having 6 or more and 12 or less carbon atoms may be any of monocyclic or polycyclic. The number of carbon atoms of the aryl group is, for example, preferably 6 or more and 10 or less and more preferably 6 or more and 9 or less.

In Formula (A), the alkyl group in the alkoxy group having 1 or more and 6 or less carbon atoms may be linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

In Formula (A), examples of the linear alkyl group having 1 or more and 10 or less carbon atoms include a methyl group, an ethyl group, an n-propyl group, an n-butyl group, an n-pentyl group, an n-hexyl group, an n-heptyl group, an n-octyl group, an n-nonyl group, and an n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups to which these monocyclic alkyl groups are linked.

In Formula (A), examples of the aryl group having 6 or more and 12 or less carbon atoms include a phenyl group, a biphenyl group, a 1-naphthyl group, and a 2-naphthyl group.

In Formula (A), examples of the linear alkoxy group having 1 or more and 6 or less carbon atoms include a methoxy group, an ethoxy group, an n-propoxy group, an n-butoxy group, an n-pentyloxy group, and an n-hexyloxy group.

In Formula (A), examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

In Formula (A), examples of the cyclic alkoxy group having 3 or more and 6 or less carbon atoms include a cyclopropoxy group, a cyclobutoxy group, a cyclopentyloxy group, and a cyclohexyloxy group.

In a case where m¹ represents 1, 2, 3, or 4 in Formula (A), Ra¹ represents, for example, preferably a linear alkyl group having 1 or more and 6 or less carbon atoms or a branched alkyl group having 3 or more and 6 or less carbon atoms, more preferably a linear alkyl group having 1 or more and 4 or less carbon atoms or a branched alkyl group having 3 or 4 carbon atoms, and still more preferably a methyl group or an ethyl group.

Hereinafter, dicarboxylic acid units (A-1) to (A-13) are shown as specific examples of the dicarboxylic acid unit (A). The dicarboxylic acid unit (A) is not limited thereto.

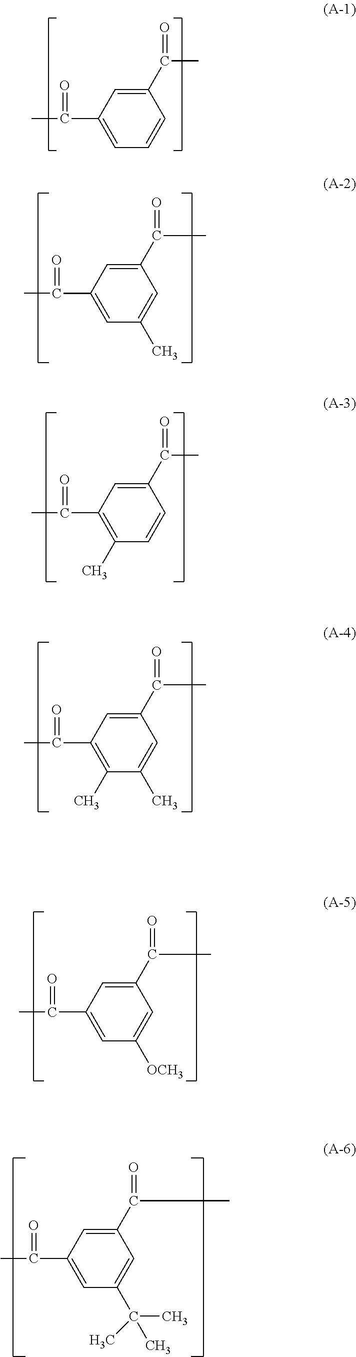

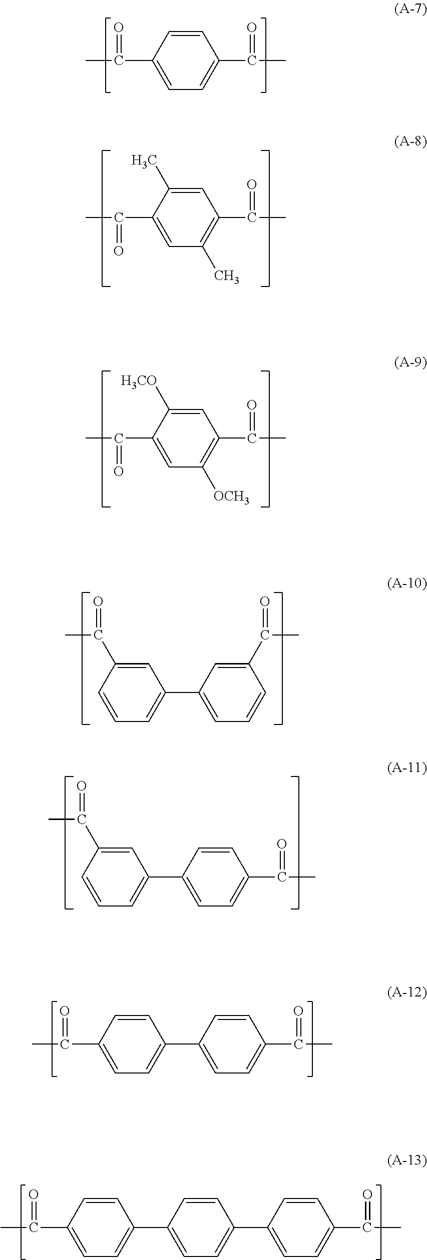

As the dicarboxylic acid unit (A), for example, (A-1), (A-7), and (A-12) in the specific examples shown above are preferable, and (A-12) is most preferable.

The dicarboxylic acid unit (A) contained in the polyester resin (1) may be used alone or in combination of two or more kinds thereof.

The diol unit (B) is a constitutional unit represented by Formula (B).

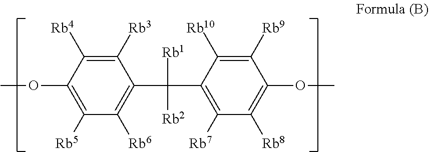

In Formula (B), Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

In Formula (B), the alkyl group having 1 or more and 20 or less carbon atoms as Rb¹ and Rb² may be linear, branched, or cyclic. The number of carbon atoms of the alkyl group is, for example, preferably 1 or more and 15 or less, more preferably 1 or more and 12 or less, and still more preferably 1 or more and 10 or less.

In Formula (B), the aryl group having 6 or more and 12 or less carbon atoms as Rb¹ and Rb² may be any of monocyclic or polycyclic. The number of carbon atoms of the aryl group is, for example, preferably 6 or more and 10 or less and more preferably 6 or more and 9 or less.

In Formula (B), the aryl group in the aralkyl group having 7 or more and 20 or less carbon atoms as Rb¹ and Rb² may be any of monocyclic or polycyclic, and the alkyl group in the aralkyl group having 7 or more and 20 or less carbon atoms may be any of linear, branched, or cyclic. The number of carbon atoms of the aryl group is, for example, preferably 6 or more and 10 or less and more preferably 6 or more and 9 or less. The number of carbon atoms of the alkyl group is, for example, preferably 1 or more and 6 or less, more preferably 1 or more and 5 or less, and still more preferably 1 or more and 4 or less.

In Formula (B), the number of carbon atoms of the cyclic alkyl group that may be formed by Rb¹ and Rb² being bonded to each other is, for example, preferably 5 or more and 15 or less and more preferably 6 or more and 12 or less.

In Formula (B), the alkyl group having 1 or more and 10 or less carbon atoms as Rb³, Rb⁴, Rb⁵, Rb⁶, Rb⁷, Rb⁸, Rb⁹, and Rb¹⁰ may be linear, branched, or cyclic. The number of carbon atoms of the alkyl group is, for example, preferably 1 or more and 6 or less, more preferably 1 or more and 4 or less, and still more preferably 1 or 2.

In Formula (B), the aryl group having 6 or more and 12 or less carbon atoms as Rb³, Rb⁴, Rb⁵, Rb⁶, Rb⁷, Rb⁸, Rb⁹, and Rb¹⁰ may be monocyclic or polycyclic. The number of carbon atoms of the aryl group is, for example, preferably 6 or more and 10 or less and more preferably 6 or more and 9 or less.

In Formula (B), the aryl group in the aralkyl group having 7 or more and 20 or less carbon atoms as Rb³, Rb⁴, Rb⁵, Rb⁶, Rb⁷, Rb⁸, Rb⁹, and Rb¹⁰ may be any of monocyclic or polycyclic, and the alkyl group in the aralkyl group having 7 or more and 20 or less carbon atoms may be linear, branched, or cyclic. The number of carbon atoms of the aryl group is, for example, preferably 6 or more and 10 or less and more preferably 6 or more and 9 or less. The number of carbon atoms of the alkyl group is, for example, preferably 1 or more and 6 or less, more preferably 1 or more and 5 or less, and still more preferably 1 or more and 4 or less.

In Formula (B), the alkyl group in the alkoxy group having 1 or more and 6 or less carbon atoms as Rb³, Rb⁴, Rb⁵, Rb⁶, Rb⁷, Rb⁸, Rb⁹, and Rb¹⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

In Formula (B), examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups to which these monocyclic alkyl groups are linked.

In Formula (B), examples of the aryl group having 6 or more and 12 or less carbon atoms include a phenyl group, a biphenyl group, a 1-naphthyl group, and a 2-naphthyl group.

In Formula (B), examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

In Formula (B), examples of the linear alkoxy group having 1 or more and 6 or less carbon atoms include a methoxy group, an ethoxy group, an n-propoxy group, an n-butoxy group, an n-pentyloxy group, and an n-hexyloxy group.

In Formula (B), examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

In Formula (B), examples of the cyclic alkoxy group having 3 or more and 6 or less carbon atoms include a cyclopropoxy group, a cyclobutoxy group, a cyclopentyloxy group, and a cyclohexyloxy group.

In Formula (B), for example, it is preferable that Rb¹ and Rb² each independently represent a hydrogen atom, a linear alkyl group having 1 or more and 12 or less carbon atoms, a branched alkyl group having 1 or more and 12 or less carbon atoms, an aryl group having 6 or more and 10 or less carbon atoms, or an aralkyl group having 7 or more and 10 or less carbon atoms or Rb¹ and Rb² are bonded to each other to form a cyclic alkyl group having 5 or more and 12 or less carbon atoms.

In Formula (B), for example, it is more preferable that Rb¹ and Rb² each independently represent a hydrogen atom, a linear alkyl group having 1 or more and 10 or less carbon atoms or a branched alkyl group having 1 or more and 10 or less carbon atoms or Rb¹ and Rb² are bonded to each other to form a cyclic alkyl group having 5 or more and 12 or less carbon atoms.

In Formula (B), for example, it is still more preferable that Rb¹ and Rb² each independently represent a hydrogen atom, a linear alkyl group having 1 or more and 10 or less carbon atoms, or a branched alkyl group having 1 or more and 10 or less carbon atoms.

In Formula (B), for example, it is preferable that at least one of Rb¹ or Rb² represents a linear alkyl group having 4 or more and 10 or less carbon atoms, a branched alkyl group having 4 or more and 10 or less carbon atoms, an aryl group having 6 or more and 10 or less carbon atoms, or an aralkyl group having 7 or more and 10 or less carbon atoms or Rb¹ and Rb² are bonded to each other to form a cyclic alkyl group having 5 or more and 12 or less carbon atoms.

In Formula (B), for example, it is more preferable that at least one of Rb¹ or Rb² represents a linear alkyl group having 4 or more and 10 or less carbon atoms or a branched alkyl group having 4 or more and 10 or less carbon atoms.

In a case where at least one of Rb¹ or Rb² is as described above, it is preferable that the other of Rb¹ or Rb² represents, for example, a hydrogen atom or a linear alkyl group having 1 or more and 3 or less carbon atoms.

It is preferable that the diol unit (B) is, for example, a constitutional unit represented by Formula (B′).

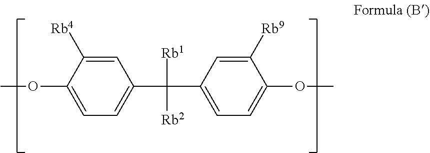

Rb¹, Rb², Rb⁴, and Rb⁹ in Formula (B′) each have the same definition as that for Rb¹, Rb², Rb⁴, and Rb⁹ in Formula (B), and the aspects thereof are the same as described above.

In Formula (B′), for example, a form in which Rb¹ represents a hydrogen atom, a linear alkyl group having 1 or more and 3 or less carbon atoms, or a branched alkyl group having 3 carbon atoms, Rb² represents a linear alkyl group having 4 or more and 10 or less carbon atoms, a branched alkyl group having 4 or more and 10 or less carbon atoms, an aryl group having 6 or more and 10 or less carbon atoms, or an aralkyl group having 7 or more and 10 or less carbon atoms, and Rb⁴ and Rb⁹ each independently represent a hydrogen atom or a methyl group is preferable; and a form in which Rb¹ represents a hydrogen atom or a methyl group, Rb² represents a linear alkyl group having 4 or more and 10 or less carbon atoms, or a branched alkyl group having 4 or more and 10 or less carbon atoms, and Rb⁴ and Rb⁹ each independently represent a hydrogen atom or a methyl group is more preferable as the diol unit (B).

Hereinafter, diol units (B-1) to (B-38) are shown as specific examples of the diol unit (B). The diol unit (B) is not limited thereto.

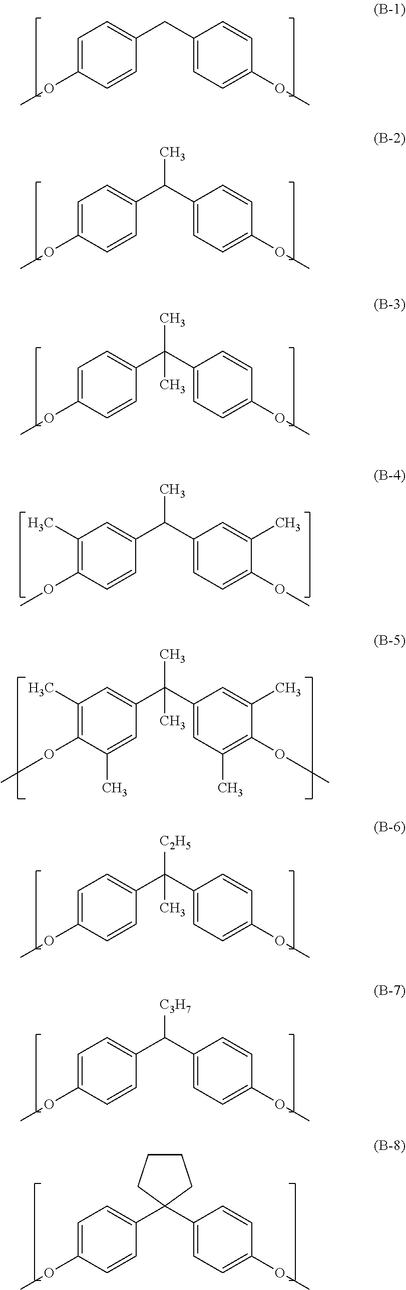

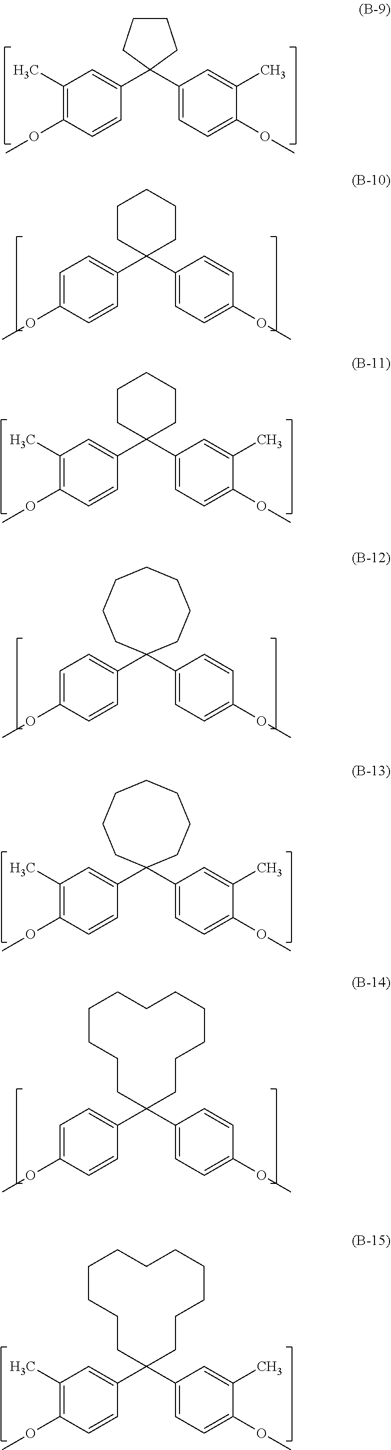

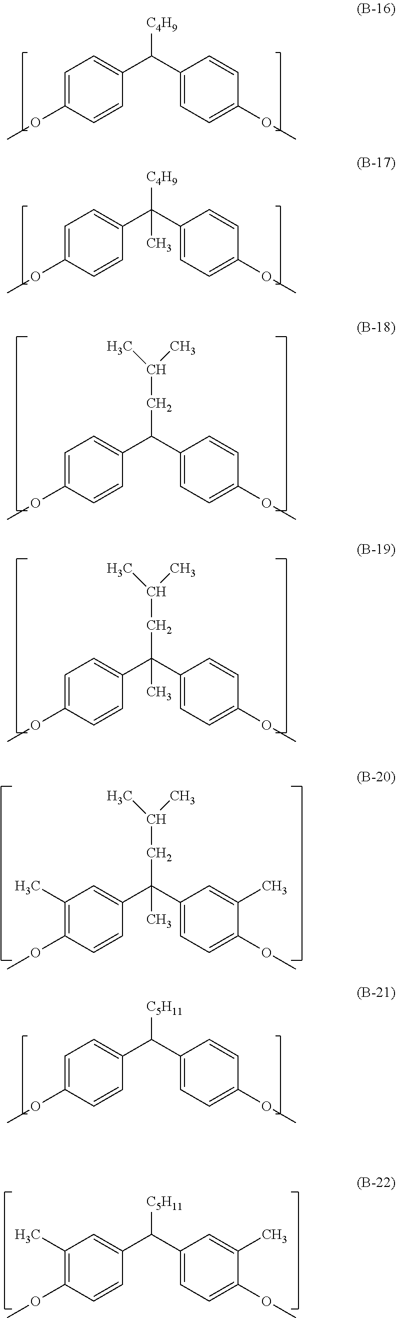

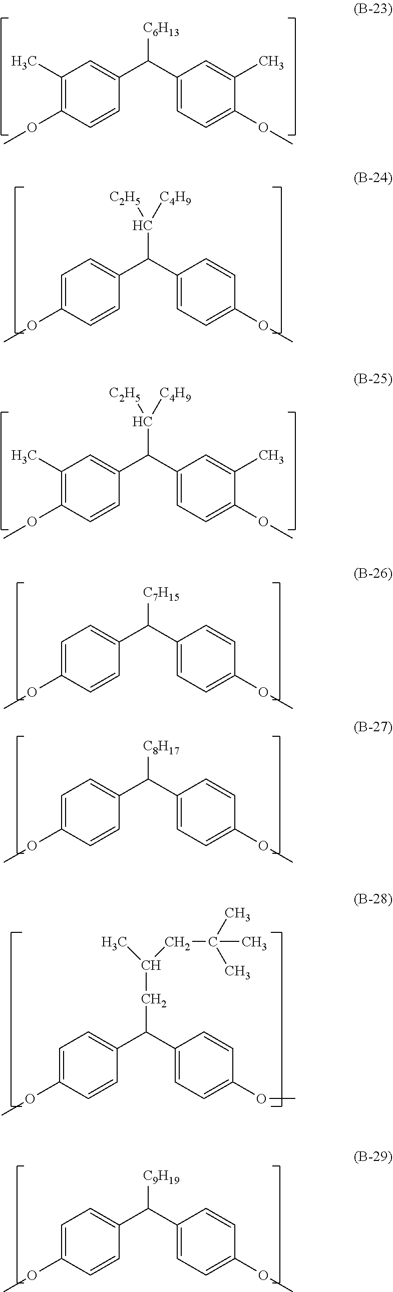

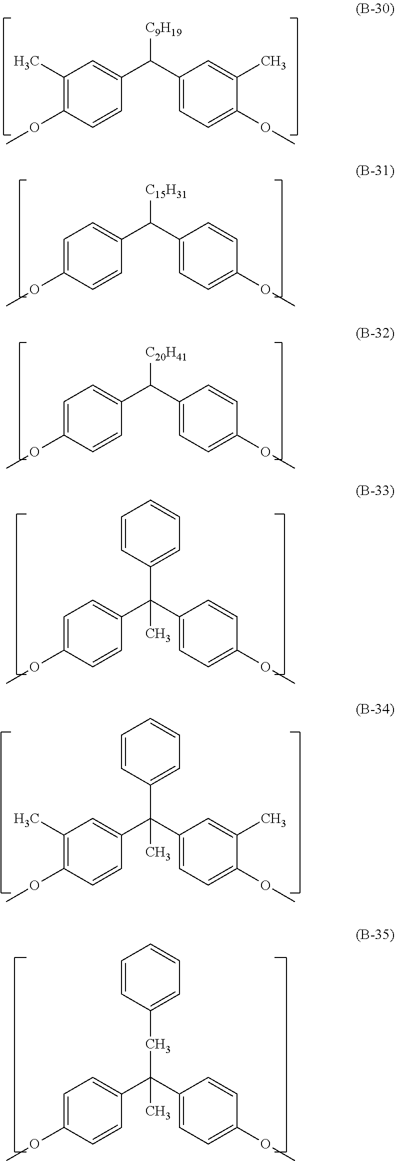

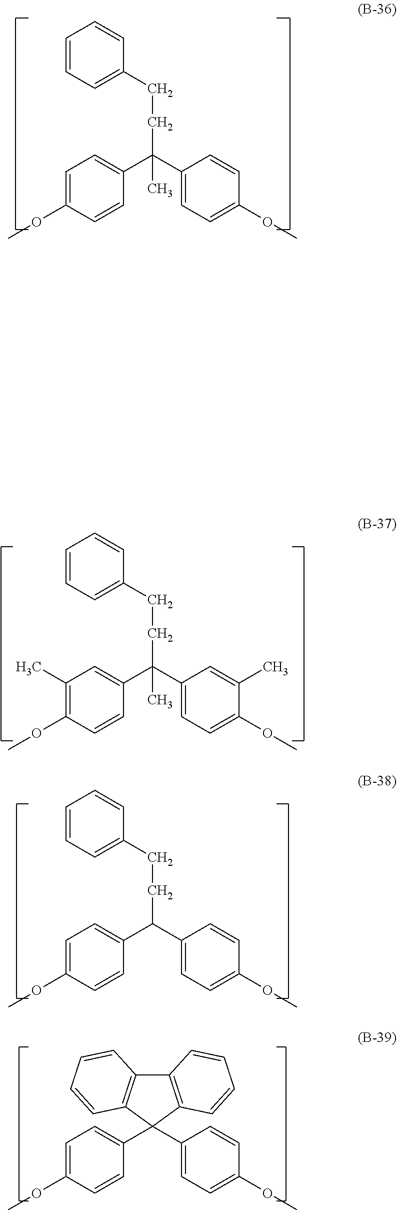

The diol unit (B) contained in the polyester resin (1) may be used alone or in combination of two or more kinds thereof.

The mass proportion of the dicarboxylic acid unit (A) in the polyester resin (1) is, for example, preferably 15% by mass or greater and 60% by mass or less.

In a case where the mass proportion of the dicarboxylic acid unit (A) is 15% by mass or greater, the abrasion resistance of the photosensitive layer is enhanced. From this viewpoint, the mass proportion of the dicarboxylic acid unit (A) is, for example, more preferably 20% by mass or greater and still more preferably 25% by mass or greater.

In a case where the mass proportion of the dicarboxylic acid unit (A) is 60% by mass or less, peeling of the photosensitive layer can be further suppressed. From this viewpoint, the mass proportion of the dicarboxylic acid unit (A) is, for example, more preferably 55% by mass or less and still more preferably 50% by mass or less.

The mass proportion of the diol unit (B) in the polyester resin (1) is, for example, preferably 25% by mass or greater and 60% by mass or less.

In a case where the mass proportion of the diol unit (B) is 25% by mass or greater, peeling of the photosensitive layer can be further suppressed. From this viewpoint, the mass proportion of the diol unit (B) is, for example, more preferably 30% by mass or greater and still more preferably 35% by mass or greater.

In a case where the mass proportion of the diol unit (B) is 60% by mass or less, the solubility in a coating solution for forming the photosensitive layer is maintained, and thus the abrasion resistance can be improved. From this viewpoint, the mass proportion of the diol unit (B) is, for example, more preferably 55% by mass or less and still more preferably 50% by mass or less.

The polyester resin (1) may have other dicarboxylic acid units in addition to the dicarboxylic acid unit (A).

Examples of other dicarboxylic acid units include a dicarboxylic acid unit (C) represented by Formula (C).

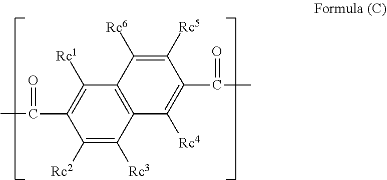

In Formula (C), Rc¹, Rc², Rc³, Rc⁴, Rc⁵, and Rc⁶ each independently represent a hydrogen atom, an alkyl group having 1 or greater and 10 or less carbon atoms, an aryl group having 6 or more and 12 or less carbon atoms, or an alkoxy group having 1 or more and 6 or less carbon atoms.

In Formula (C), the alkyl group having 1 or more and 10 or less carbon atoms may be linear, branched, or cyclic. The number of carbon atoms of the alkyl group is, for example, preferably 1 or more and 6 or less, more preferably 1 or more and 4 or less, and still more preferably 1 or 2.

In Formula (C), the aryl group having 6 or more and 12 or less carbon atoms may be any of monocyclic or polycyclic. The number of carbon atoms of the aryl group is, for example, preferably 6 or more and 10 or less and more preferably 6 or more and 9 or less.

In Formula (C), the alkyl group in the alkoxy group having 1 or more and 6 or less carbon atoms may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, and the alkoxy group in Formula (C) include the same groups as the groups described in Formula (A).

In Formula (C), Rc¹, Rc², Rc³, Rc⁴, Rc⁵, and Rc⁶ each independently represent, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom.

As the dicarboxylic acid unit (C), for example, a 2,6-naphthalenedicarboxylic acid unit (Formula (C-1)) is most preferable.

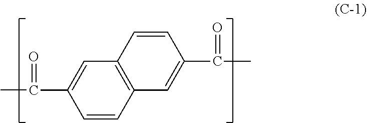

The dicarboxylic acid unit (C) contained in the polyester resin (1) may be used alone or in combination of two or more kinds thereof.

In a case where the polyester resin (1) has the dicarboxylic acid unit (C), the mass proportion of the dicarboxylic acid unit (C) in the polyester resin (1) is, for example, preferably 1% by mass or greater and 20% by mass or less.

Examples of other dicarboxylic acid units include a dicarboxylic acid unit (D) represented by Formula (D).

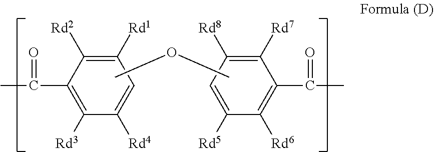

In Formula (D), Rd¹, Rd², Rd³, Rd⁴, Rd⁵, Rd⁶, Rd⁷, and Rd⁸ each independently represent a hydrogen atom, an alkyl group having 1 or more and 10 or less carbon atoms, an aryl group having 6 or more and 12 or less carbon atoms, or an alkoxy group having 1 or more and 6 or less carbon atoms.

In Formula (D), the alkyl group having 1 or more and 10 or less carbon atoms may be any of linear, branched, or cyclic. The number of carbon atoms of the alkyl group is, for example, preferably 1 or more and 6 or less, more preferably 1 or more and 4 or less, and still more preferably 1 or 2.

In Formula (D), the aryl group having 6 or more and 12 or less carbon atoms may be any of monocyclic or polycyclic. The number of carbon atoms of the aryl group is, for example, preferably 6 or more and 10 or less and more preferably 6 or more and 9 or less.

In Formula (D), the alkyl group in the alkoxy group having 1 or more and 6 or less carbon atoms may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, and the alkoxy group in Formula (D) include the same groups as the groups described in Formula (A).

In Formula (D), Rd¹, Rd², Rd³, Rd⁴, Rd⁵, Rd⁶, Rd⁷, and Rd⁸ each independently represent, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom.

It is preferable that the dicarboxylic acid unit (D) is, for example, a constitutional unit represented by Formula (D′).

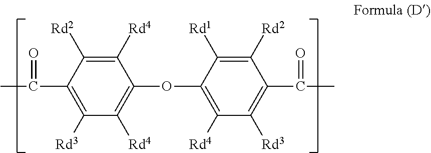

Rd¹, Rd², Rd³, and Rd⁴ in Formula (D′) each have the same definition as that for Rd¹, Rd², Rd³, and Rd⁴ in Formula (D), and the aspects thereof are the same as described above.

For example, a diphenyl ether-4,4′-dicarboxylic acid unit (Formula (D-1)) is most preferable as the dicarboxylic acid unit (D).

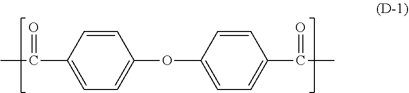

The dicarboxylic acid unit (D) contained in the polyester resin (1) may be used alone or in combination of two or more kinds thereof.

In a case where the polyester resin (1) has the dicarboxylic acid unit (D), the mass proportion of the dicarboxylic acid unit (D) in the polyester resin (1) is, for example, preferably 1% by mass or greater and 20% by mass or less.

Examples of other dicarboxylic acid units include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower (for example, having 1 or more and 5 or less carbon atoms) alkyl ester units thereof. These dicarboxylic acid units contained in the polyester resin (1) may be used alone or in combination of two or more kinds thereof.

The polyester resin (1) may have other diol units in addition to the diol unit (B).

Examples of other diol units include a diol unit (E) represented by Formula (E).

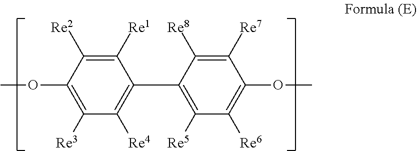

In Formula (E), Re¹, Re², Re³, Re⁴, Re⁵, Re⁶, Re⁷, and Re⁸ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms.

In Formula (E), the alkyl group having 1 or more and 10 or less carbon atoms may be any of linear, branched, or cyclic. The number of carbon atoms of the alkyl group is, for example, preferably 1 or more and 6 or less, more preferably 1 or more and 4 or less, and still more preferably 1 or 2.

In Formula (E), the aryl group having 6 or more and 12 or less carbon atoms may be any of monocyclic or polycyclic. The number of carbon atoms of the aryl group is, for example, preferably 6 or more and 10 or less and more preferably 6 or more and 9 or less.

In Formula (E), the aryl group in the aralkyl group having 7 or more and 20 or less carbon atoms may be any of monocyclic or polycyclic, and the alkyl group in the aralkyl group having 7 or more and 20 or less carbon atoms is any of linear, branched, or cyclic. The number of carbon atoms of the aryl group is, for example, preferably 6 or more and 10 or less and more preferably 6 or more and 9 or less. The number of carbon atoms of the alkyl group is, for example, preferably 1 or more and 6 or less, more preferably 1 or more and 5 or less, and still more preferably 1 or more and 4 or less.

In Formula (E), the alkyl group in the alkoxy group having 1 or more and 6 or less carbon atoms may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, the aralkyl group, and the alkoxy group in Formula (E) include the same groups as the groups described in Formula (B).

In Formula (E), Re¹, Re², Re³, Re⁴, Re⁵, Re⁶, Re⁷, and Re⁸ each independently represent, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom or a methyl group.

It is preferable that the diol unit (E) is, for example, a constitutional unit represented by Formula (E′).

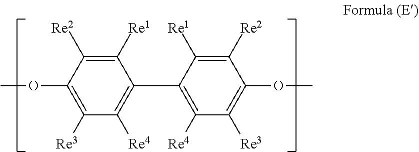

Re¹, Re², Re³, and Re⁴ in Formula (E′) each have the same definition as that for Re¹, Re², Re³, and Re⁴ in Formula (E), and the aspects thereof are the same as described above.

For example, any of Formulae (E-1) to (E-3) is most preferable as the diol unit (E).

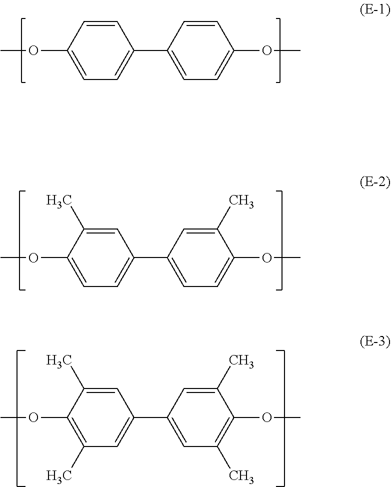

The diol unit (E) contained in the polyester resin (1) may be used alone or in combination of two or more kinds thereof.

In a case where the polyester resin (1) has a diol unit (E), the mass proportion of the diol unit (E) in the polyester resin (1) is, for example, preferably 1% by mass or greater and 20% by mass or less.

Examples of other diol units include a diol unit (F) represented by Formula (F).

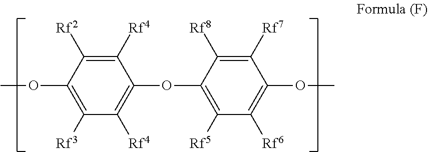

In Formula (F), Rf¹, Rf², Rf³, Rf⁴, Rf⁵, Rf⁶, Rf⁷, and Rf⁸ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms.

In Formula (F), the alkyl group having 1 or more and 10 or less carbon atoms may be any of linear, branched, or cyclic. The number of carbon atoms of the alkyl group is, for example, preferably 1 or more and 6 or less, more preferably 1 or more and 4 or less, and still more preferably 1 or 2.

In Formula (F), the aryl group having 6 or more and 12 or less carbon atoms may be any of monocyclic or polycyclic. The number of carbon atoms of the aryl group is, for example, preferably 6 or more and 10 or less and more preferably 6 or more and 9 or less.

In Formula (F), the aryl group in the aralkyl group having 7 or more and 20 or less carbon atoms may be any of monocyclic or polycyclic, and the alkyl group in the aralkyl group having 7 or more and 20 or less carbon atoms may be any of linear, branched, or cyclic. The number of carbon atoms of the aryl group is, for example, preferably 6 or more and 10 or less and more preferably 6 or more and 9 or less. The number of carbon atoms of the alkyl group is, for example, preferably 1 or more and 6 or less, more preferably 1 or more and 5 or less, and still more preferably 1 or more and 4 or less.

In Formula (F), the alkyl group in the alkoxy group having 1 or more and 6 or less carbon atoms may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, the aralkyl group, and the alkoxy group in Formula (F) include the same groups as the groups described in Formula (B).

In Formula (F), Rf¹, Rf², Rf³, Rf⁴, Rf⁵, Rf⁶, Rf⁷, and Rf⁸ each independently represent, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom or a methyl group.

It is preferable that the diol unit (F) is, for example, a constitutional unit represented by Formula (F′).

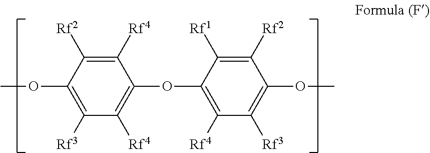

Rf¹, Rf², Rf³, and Rf⁴ in Formula (F′) each have the same definition as that for Rf¹, Rf², Rf³, and Rf⁴ in Formula (F), and the aspects thereof are the same as described above.

For example, a bis(4-hydroxyphenyl) ether unit (Formula (F-1)) is most preferable as the diol unit (F).

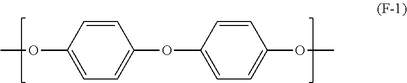

The diol unit (F) contained in the polyester resin (1) may be used alone or in combination of two or more kinds thereof.

In a case where the polyester resin (1) has a diol unit (F), the mass proportion of the diol unit (F) in the polyester resin (1) is, for example, preferably 1% by mass or greater and 20% by mass or less.

Examples of other diol units include aliphatic diol (such as ethylene glycol, diethylene glycol, triethylene glycol, propylene glycol, butanediol, hexanediol, and neopentyl glycol) units and alicyclic diol (such as cyclohexanediol, cyclohexane dimethanol, and hydrogenated bisphenol A) units. These diol units contained in the polyester resin (1) may be used alone or in combination of two or more kinds thereof.

Examples of the method of producing the polyester resin (1) include an interfacial polymerization method, a solution polymerization method, and a melt polymerization method.

A terminal of the polyester resin (1) may be sealed or modified with a terminal-sealing agent, a molecular weight modifier, or the like used in a case of the production. Examples of the terminal-sealing agent or the molecular weight modifier include monohydric phenol, monovalent acid chloride, monohydric alcohol, and monovalent carboxylic acid.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of the monovalent acid chloride include monofunctional acid halides such as benzoyl chloride, benzoic acid chloride, methanesulfonyl chloride, phenylchloroformate, acetic acid chloride, butyric acid chloride, octyl acid chloride, benzenesulfonyl chloride, benzenesulfinyl chloride, sulfinyl chloride, benzene phosphonyl chloride, and substituents thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monovalent carboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

The content of the polyester resin (1) is, for example, preferably 35% by mass or greater and 65% by mass or less and more preferably 40% by mass or greater and 60% by mass or less with respect to the total solid content of the charge transport layer.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 1×10¹³ Ω·cm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary, and it is appropriate for longer life because occurrence of defects due to the unevenness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the micropores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by dipping the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ω·cm or greater and 1×10¹¹ Ω·cm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, the undercoat layer may contain an electron-accepting compound (acceptor compound) together with the inorganic particles, for example, from the viewpoint of enhancing the long-term stability of the electrical properties and the carrier blocking properties.

Examples of the electron-accepting compound include electron-transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; and a diphenoquinone compound such as 3,3′,5,5′-tetra-t-butyldiphenoquinone.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent by performing stirring or using ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached to the surface before the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and preferably 0.01% by mass or greater and 10% by mass or less with respect to the amount of the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles when preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical methods such as a blade coating method, a wire bar coating method, a spray coating method, a dip coating method, a bead coating method, an air knife coating method, and a curtain coating method.

The thickness of the undercoat layer is set to be, for example, preferably 15 μm or greater and more preferably in a range of 20 μm or greater and 50 μm or less.

### Interlayer

An interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical methods such as a dip coating method, a push-up coating method, a wire bar coating method, a spray coating method, a blade coating method, an air knife coating method, and a curtain coating method.

The thickness of the interlayer is set to be, for example, preferably in a range of 0.1 μm or greater and 3 μm or less. The interlayer may be used as the undercoat layer.

### Charge Generation Layer

The charge generation layer is, for example, a layer containing a charge generation material and a binder resin. Further, the charge generation layer may be a deposition layer of the charge generation material. The deposition layer of the charge generation material is, for example, preferable in a case where an incoherent light source such as a light emitting diode (LED) or an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine; chlorogallium phthalocyanine; dichlorotin phthalocyanine; and titanyl phthalocyanine are more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used.

Meanwhile, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 1×10¹³ Ω·cm or greater.

These binder resins may be used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The thickness of the charge generation layer is set to be, for example, preferably in a range of 0.1 μm or greater and 5.0 μm or less and more preferably in a range of 0.2 μm or greater and 2.0 μm or less.

### Charge Transport Layer

The charge transport layer contains a polyester resin (1) having a dicarboxylic acid unit (A) represented by Formula (A) and a diol unit (B) represented by Formula (B), and a charge transport material. The charge transport layer may further contain other binder resins in addition to the polyester resin (1).

The details of the polyester resin (1) are as described above.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

From the viewpoint of the charge mobility, for example, a triarylamine derivative represented by Structural Formula (a-1) or a benzidine derivative represented by Structural Formula (a-2) is preferable as the charge transport material.

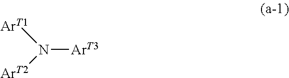

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

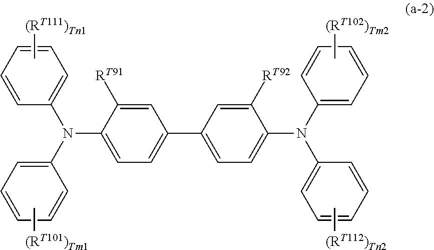

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), and R^{T12}R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less. Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” and a benzidine derivative having “—CH═CH—CH═C(R^{T15})(R^{T16})” are particularly preferable from the viewpoint of the charge mobility.

As the polymer charge transport material, known materials having charge transport properties, such as poly-N-vinylcarbazole and polysilane, can be used. Particularly, for example, a polyester-based polymer charge transport material is particularly preferable. The polymer charge transport material may be used alone or in combination of binder resins.

Examples of the charge transport material or the polymer charge transport material include a polycyclic aromatic compound, a heterocyclic compound, a hydrazone compound, a styryl compound, an enamine compound, a benzidine compound, a triarylamine compound, a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, and a resin containing a group derived from any of these substances. Specific examples thereof include compounds described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, and paragraph 0116 of JP2013-097300A.

The content of the charge transport material contained in the charge transport layer may be, for example, 28% by mass or greater and 55% by mass or less with respect to the total solid content.

The charge transport layer contains at least the polyester resin (1) as a binder resin. The proportion of the polyester resin (1) in the total amount of the binder resin contained in the charge transport layer is, for example, preferably 50% by mass or greater, more preferably 80% by mass or greater, still more preferably 90% by mass or greater, particularly preferably 95% by mass or greater, and most preferably 100% by mass.

The charge transport layer may contain other binder resins in addition to the polyester resin (1). Examples of other binder resins include a polyester resin other than the polyester resin (1), a polycarbonate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. These binder resins may be used alone or in combination of two or more kinds thereof.

The charge transport layer may also contain other known additives. Examples of the additives include an antioxidant, a leveling agent, an antifoaming agent, a filler, and a viscosity adjuster.

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

The average thickness of the charge transport layer is, for example, preferably 10 m or greater and 50 μm or less, more preferably 15 μm or greater and 45 μm or less, and still more preferably 20 μm or greater and 40 μm or less.

### Surface Protective Layer

The surface protective layer is a cured film with a composition containing a curing agent having at least one of a guanamine compound or a melamine compound, and at least one reactive group-containing charge transport material having at least one substituent selected from the group consisting of —OH, —OCH₃, —NH₂, —SH, and —COOH. The composition may contain other materials in addition to the curing agent and the reactive group-containing charge transport material.

### Reactive Group-Containing Charge Transport Material

The reactive group-containing charge transport material has at least one substituent selected from the group consisting of —OH, —OCH₃, —NH₂, —SH, and —COOH and, for example, preferably at least one substituent of —OH or —OCH₃.

The surface protective layer formed of a reactive group-containing charge transport material having —OH as a substituent has a low affinity for the charge transport layer in an unreacted state, but tends to have a high affinity for the charge transport layer after the reaction. As a result, as the reaction of the surface protective layer progresses, the affinity between the surface protective layer and the charge transport layer increases. As a result, the charges are easily injected, the adhesiveness is improved, and the surface protective layer is further suppressed from being peeled off and being floated from the charge transport layer.

The reactive group-containing charge transport material may be used alone or in combination of two or more kinds thereof.

It is desirable that the reactive group-containing charge transport material is, for example, a compound represented by General Formula (I).

F—((—R¹³—X)ₙ₁(R¹⁴)ₙ₂—Y)ₙ₃ (I)

In General Formula (I), F represents an organic group derived from a compound having a positive hole-transporting ability, R¹³ and R¹⁴ each independently represent a linear or branched alkylene group having 1 or more and 5 or less carbon atoms, n1 represents 0 or 1, n2 represents 0 or 1, and n3 represents an integer of 1 or greater and 4 or less. X represents an oxygen atom, NH, or a sulfur atom, and Y represents —OH, —OCH₃, —NH₂, —SH, or —COOH.

In General Formula (I), examples of the compound having a positive hole-transporting ability in the organic group derived from the compound having a positive hole-transporting ability represented by F include an arylamine derivative. Examples of the arylamine derivative include a triphenylamine derivative and a tetraphenylbenzidine derivative.

The compound represented by General Formula (I) is, for example, desirably a compound represented by General Formula (II). The compound represented by General Formula (II) is particularly excellent in charge mobility, stability to oxidation, and the like.

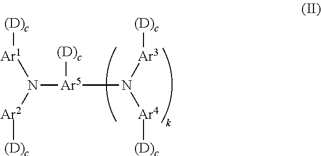

In General Formula (II), Ar¹ to Ar⁴ may be the same as or different from each other and each independently represent a substituted or unsubstituted aryl group, Ar⁵ represents a substituted or unsubstituted aryl group or a substituted or unsubstituted arylene group, D represents —(—R¹³—X)ₙ₁(R¹⁴)ₙ₂—Y, c's each independently represent 0 or 1, k represents 0 or 1, and the total number of D's is 1 or more and 4 or less. Further, R¹³ and R¹⁴ each independently represent a linear or branched alkylene group having 1 or more and 5 or less carbon atoms, n1 represents 0 or 1, n2 represents 0 or 1, X represents an oxygen atom, NH, or a sulfur atom, and Y represents —OH, —OCH₃, —NH₂, —SH, or —COOH.

In General Formula (II), “—(—R¹³—X)ₙ₁(R¹⁴)ₙ₂—Y” represented by D has the same definition as that for General Formula (I), and R¹³ and R¹⁴ each independently represent a linear or branched alkylene group having 1 or more and 5 or less carbon atoms. Further, it is preferable that n1 represents, for example, 1. Further, it is preferable that n2 represents, for example, 1. Further, it is preferable that X represents, for example, an oxygen atom. Further, it is preferable that Y represents, for example, at least one of —OH or —OCH₃.

The total number of D's in General Formula (II) corresponds to n3 in General Formula (I) and is, for example, preferably 2 or greater and 4 or less and more preferably 3 or greater and 4 or less.

In General Formula (I) or General Formula (II), in a case where the total number of D's is set to 2 or greater and 4 or less, for example, preferably 3 or greater and 4 or less in one molecule, the crosslinking density is increased and a crosslinked film with higher strength is likely to be obtained.

In General Formula (II), it is desirable that Ar₁ to Ar₄ represent, for example, any of Formulae (1) to (7). Further, Formulae (1) to (7) are shown together with “-(D)_{C}” that can be linked to each of Ar₁ to Ar₄.

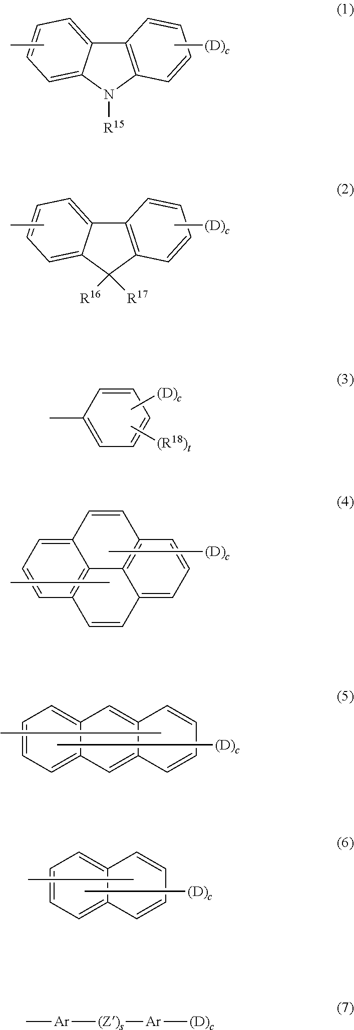

In Formulae (1) to (7), R¹⁵ represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, R¹⁶ to R¹⁸ each represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, Ar represents a substituted or unsubstituted arylene group, D and c each have the same definition as that for “D” and “c” in General Formula (II), s represents 0 or 1, and t represents an integer of 1 or greater and 3 or less.

It is desirable that Ar in Formula (7) is, for example, represented by Formula (8) or (9).

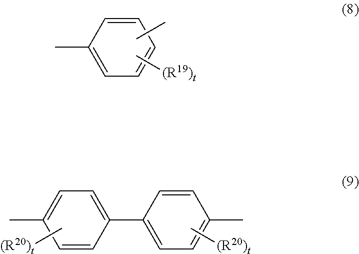

In Formulae (8) and (9), R¹⁹ and R²⁰ each represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, and t represents an integer of 1 or greater and 3 or less.

It is desirable that Z′ in Formula (7) is, for example, represented by any of Formulae (10) to (17).

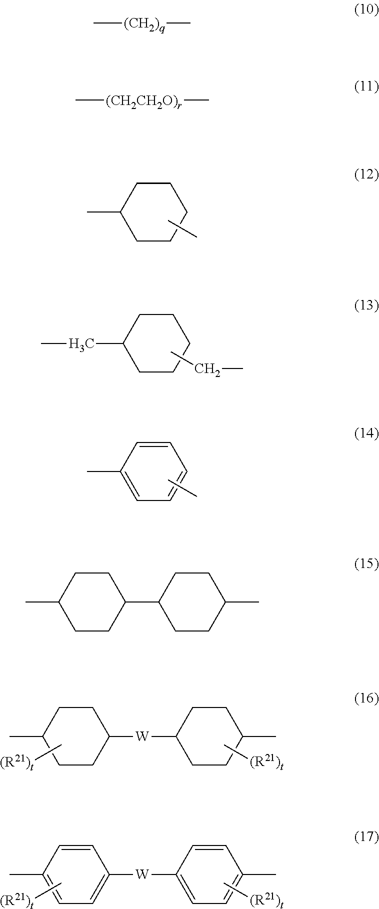

In Formulae (10) to (17), R²¹ and R²² each represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, W represents a divalent group, q and r each represents an integer of 1 or greater and 10 or less, and t's each represents an integer of 1 or greater and 3 or less.

It is desirable that W in Formulae (16) and (17) represents, for example, a divalent group represented by any of Formulae (18) to (26). Here, in Formula (25), u represents an integer of 0 or greater and 3 or less.

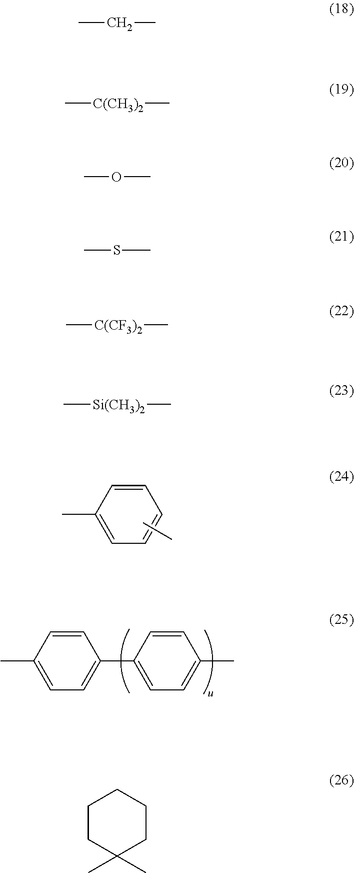

In General Formula (II), Ar⁵ represents an aryl group of Formulae (1) to (7) described in the section of Ar¹ to Ar⁴ in a case where k represents 0 and represents an arylene group obtained by removing a hydrogen atom from the aryl group of Formulae (1) to (7) in a case where k represents 1.

Specific examples of the compound represented by General Formula (I) are shown below, but the compound represented by General Formula (I) is not limited thereto.

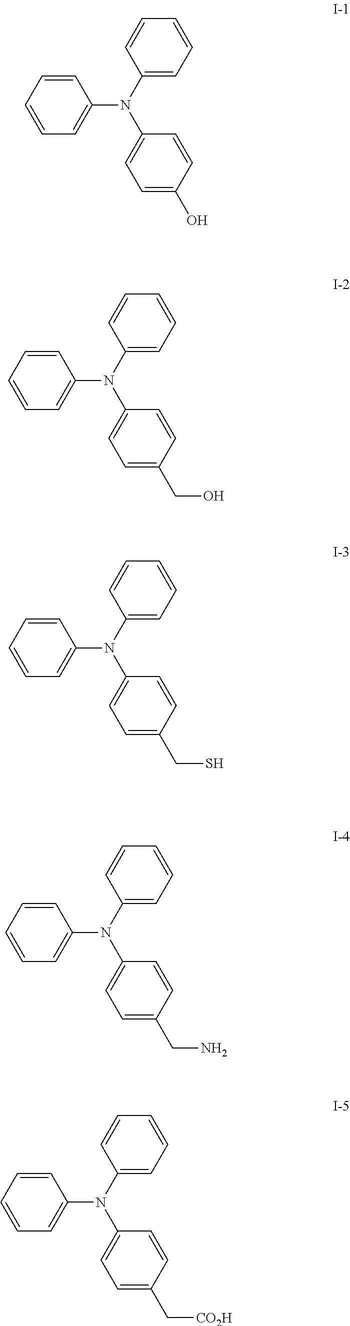

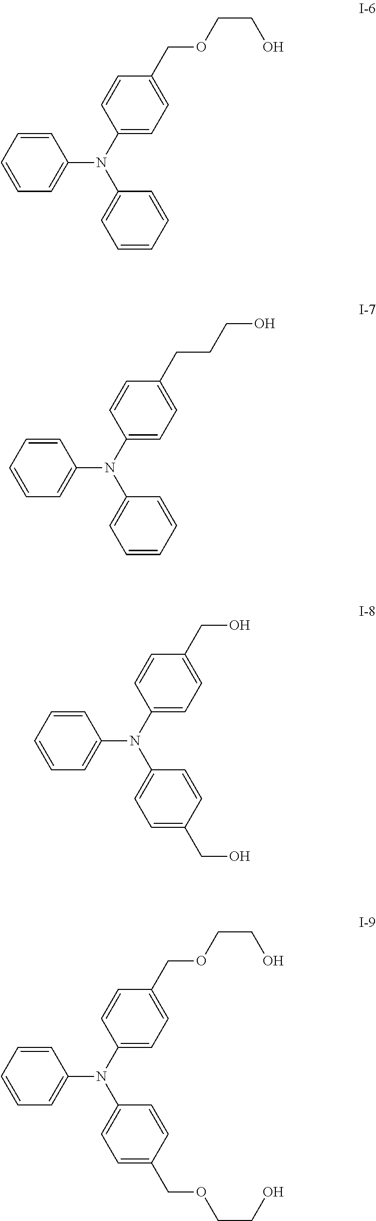

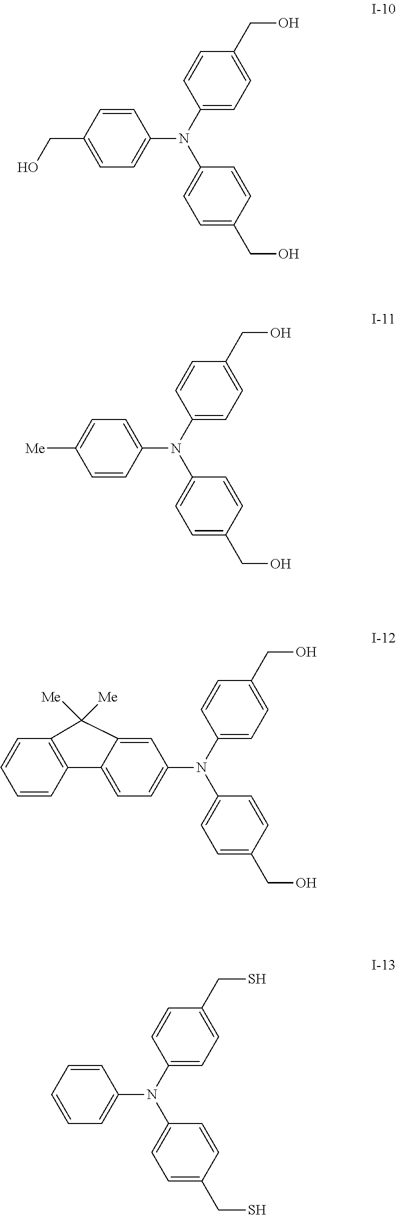

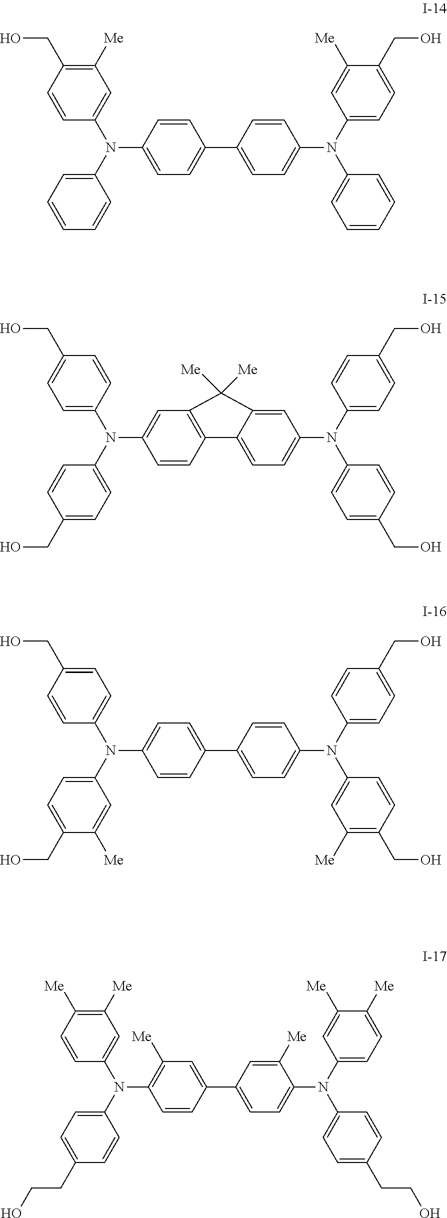

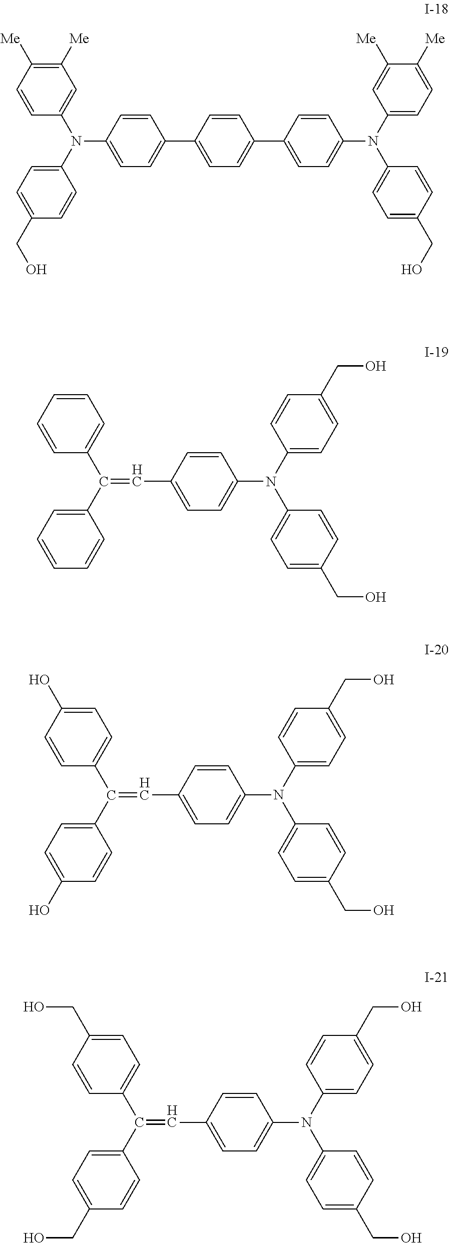

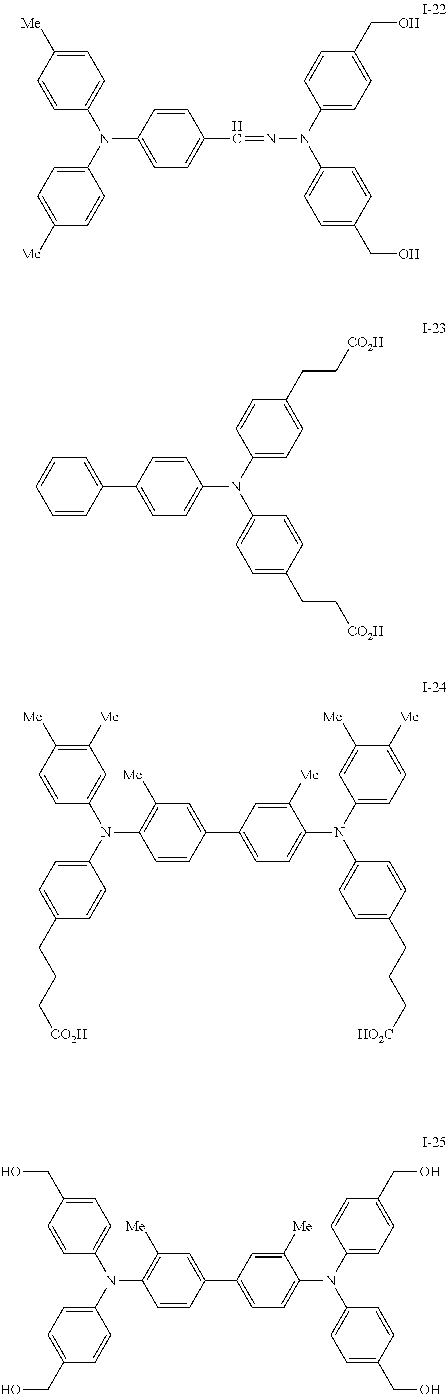

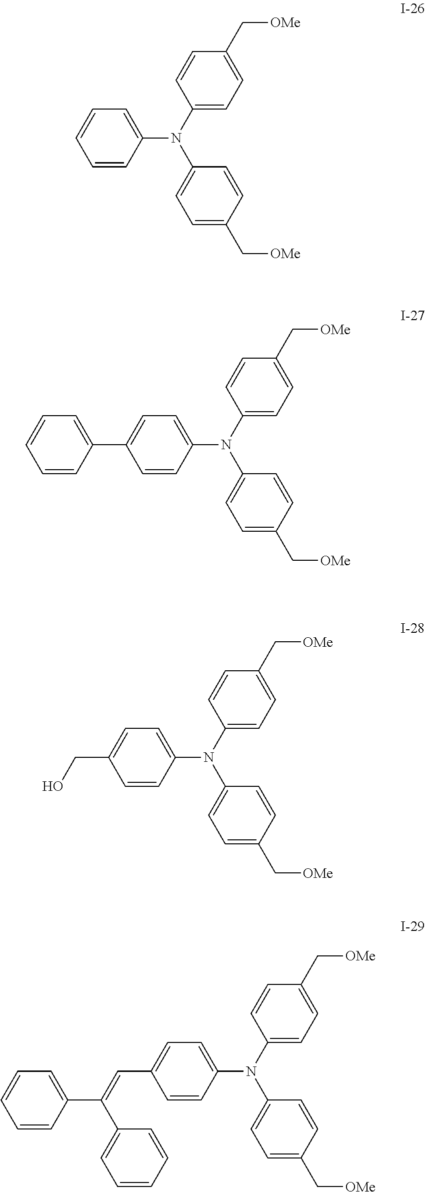

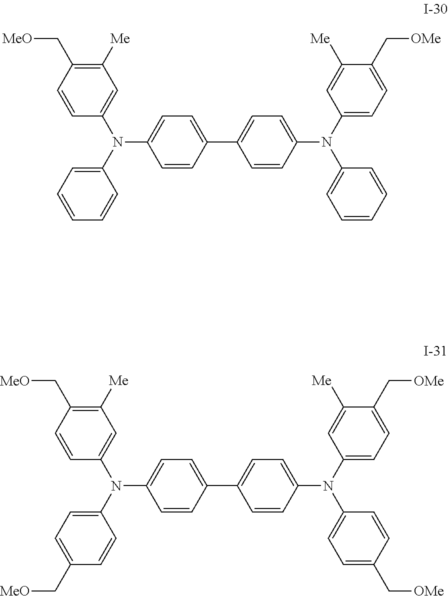

The total content (solid content concentration in the coating solution) of the specific charge transport material is, for example, preferably 90% by mass or greater and more preferably 94% by mass or greater. In a case where the solid content concentration thereof is 90% by mass or greater, a decrease in electrical properties is reduced.

### Curing Agent

The curing agent contains at least one of a guanamine compound or a melamine compound. The curing agent may be used alone or in combination of two or more kinds thereof. In the present specification, the guanamine compound denotes a compound having a guanamine structure, and the melamine compound denotes a compound having a melamine structure.

The interface of the cured film with a composition containing at least one compound selected from a guanamine compound or a melamine compound as a curing agent tends to have hydrophobicity in a case where the number of unreacted groups in the cured film is decreased due to the crosslinking reaction with the charge transport agent. As a result, the cured film is considered to have excellent adhesiveness due to a high affinity at the interface with the hydrophobic charge transport layer containing the polyester resin (1) and a strong interaction.

### Guanamine Compound

The guanamine compound is a compound having a guanamine skeleton (structure), and examples thereof include acetoguanamine, benzoguanamine, formoguanamine, steroguanamine, spiroguanamine, and cyclohexylguanamine.

It is desirable that the composition contains, for example, particularly at least one of a compound represented by General Formula (A) or a multimer thereof as the guanamine compound. Here, the multimer is an oligomer in which a compound represented by General Formula (A) is polymerized as a structural unit, and the polymerization degree thereof is, for example, 2 or greater and 200 or less (for example, preferably 2 or greater and 100 or less). Further, the compound represented by General Formula (A) may be used alone or in combination of two or more kinds thereof. In particular, in a case where two or more kinds of the compound represented by General Formula (A) are mixed and used or the compound is used as a multimer (oligomer) having the compound as a structural unit, the solubility in a solvent is improved.

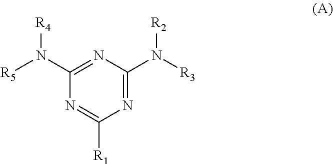

In General Formula (A), R₁ represents a linear or branched alkyl group having 1 or more and 10 or less carbon atoms, a substituted or unsubstituted phenyl group having 6 or more and 10 or less carbon atoms, or a substituted or unsubstituted alicyclic hydrocarbon group having 4 or more and 10 or less carbon atoms. R₂ to R₅ each independently represent a hydrogen atom, —CH₂—OH, or —CH₂—O—R₆. R₆ represents a linear or branched alkyl group having 1 or more and 10 or less carbon atoms.

In General Formula (A), the alkyl group represented by R₁ has 1 or more and 10 or less carbon atoms, for example, preferably 1 or more and 8 or less carbon atoms, and more preferably 1 or more and 5 or less carbon atoms. Further, the alkyl group may be linear or branched.

In General Formula (A), the phenyl group represented by R₁ has 6 or more and 10 or less carbon atoms and, for example, more preferably 6 or more and 8 or less carbon atoms. Examples of the substituent substituted with the phenyl group include a methyl group, an ethyl group, and a propyl group.

In General Formula (A), the alicyclic hydrocarbon group represented by R₁ has 4 or more and 10 or less carbon atoms and, for example, more preferably 5 or more and 8 or less carbon atoms. Examples of the substituent substituted with the alicyclic hydrocarbon group include a methyl group, an ethyl group, and a propyl group.

In “—CH₂—O—R₆” represented by R₂ to R₅ in General Formula (A), the alkyl group represented by R₆ has 1 or more and 10 or less carbon atoms, for example, preferably 1 or more and 8 or less carbon atoms, and more preferably 1 or more and 6 or less carbon atoms. Further, the alkyl group may be linear or branched. Preferred examples thereof include a methyl group, an ethyl group, and a butyl group.

It is particularly preferable that the compound represented by General Formula (A) is, for example, a compound in which R₁ represents a substituted or unsubstituted phenyl group having 6 or more and 10 or less carbon atoms and R₂ to R₅ each independently represent —CH₂—O—R₆. Further, it is desirable that R₆ represents, for example, a group selected from a methyl group or an n-butyl group.

The compound represented by General Formula (A) is synthesized, for example, by a known method using guanamine and formaldehyde (for example, edited by The Chemical Society of Japan, The fourth series of Experimental Chemistry, Vol. 28, p. 430).

Hereinafter, exemplary compounds (A)-1 to (A)-42 are shown as specific examples of the compound represented by General Formula (A), but the present exemplary embodiment is not limited thereto. Further, the following specific examples are monomers, but multimers (oligomers) having these monomers as structural units may be used. In the following exemplary compounds, “Me” represents a methyl group, “Bu” represents a butyl group, and “Ph” represents a phenyl group.

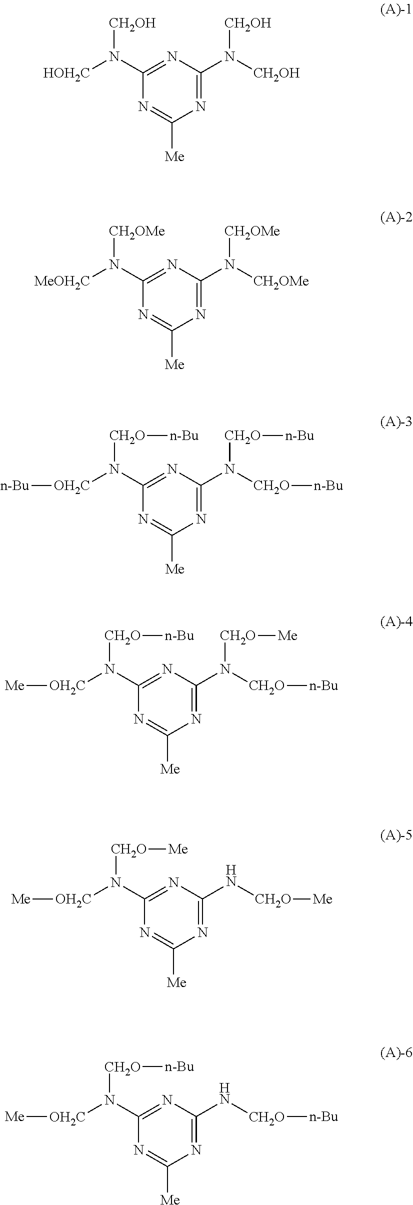

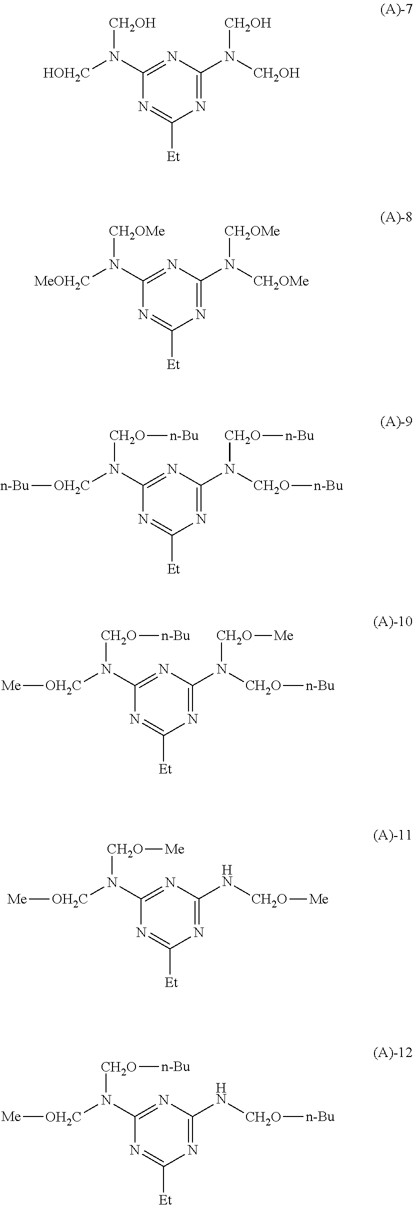

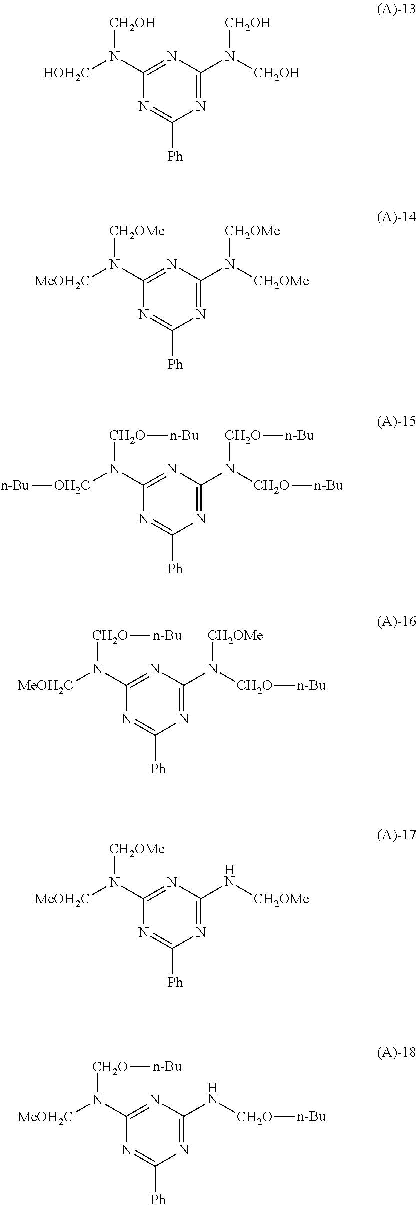

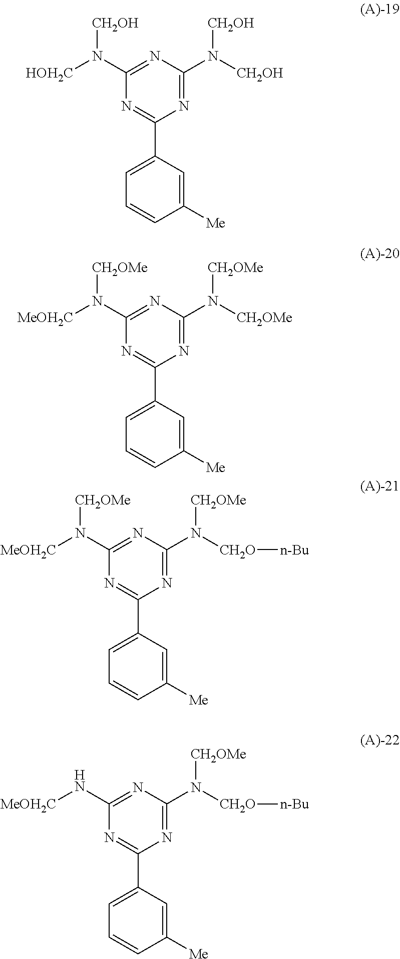

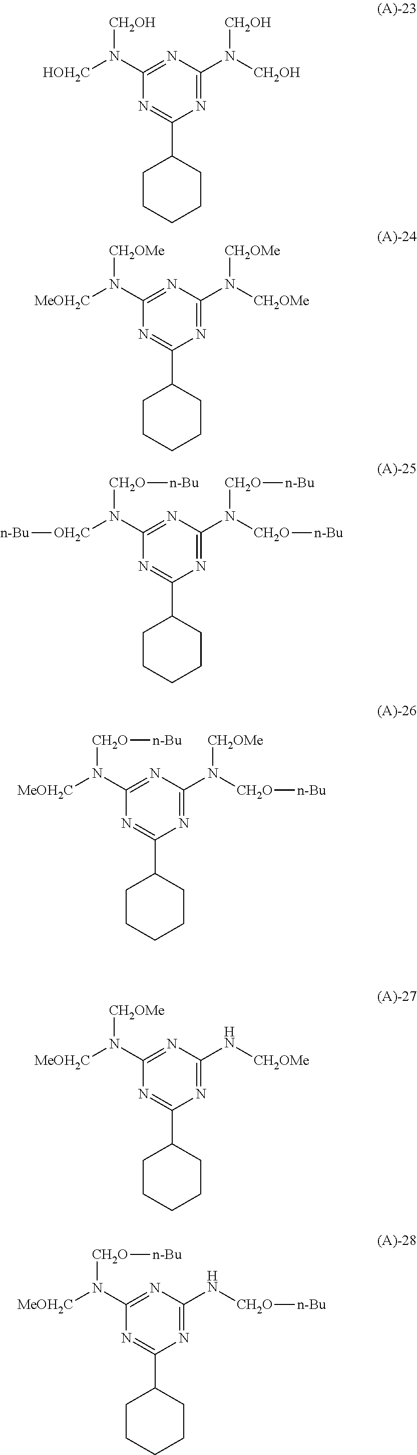

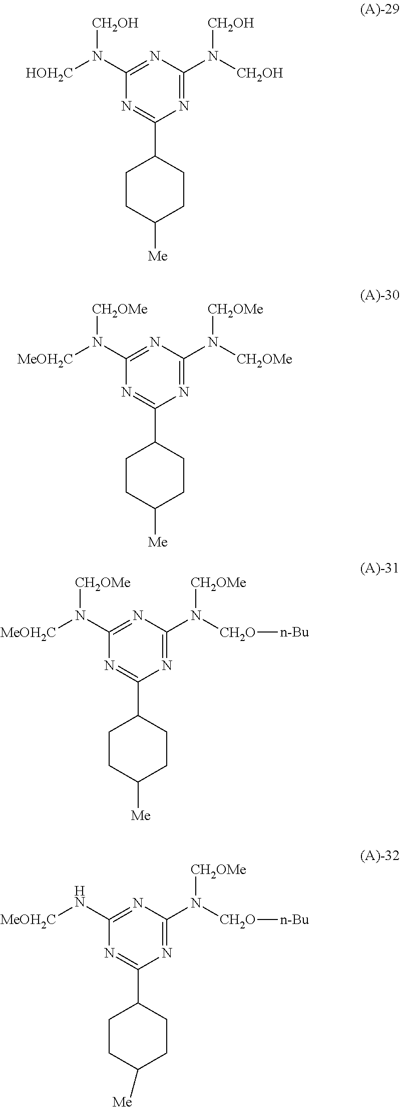

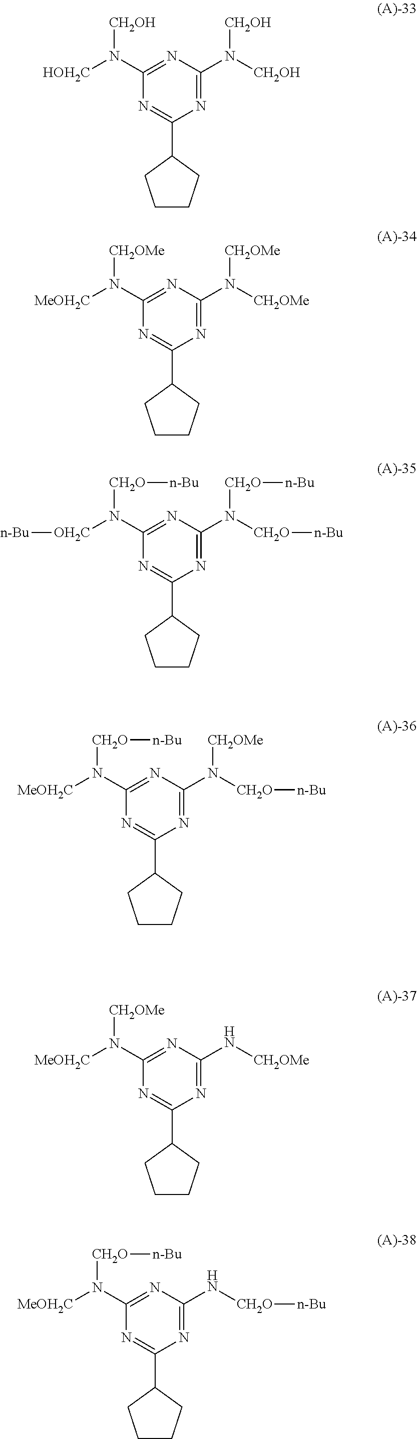

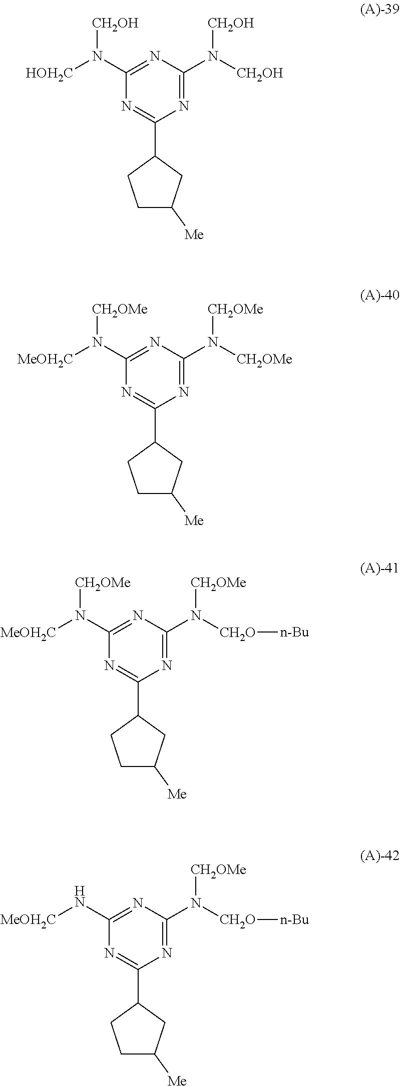

Examples of a commercially available product of the compound represented by General Formula (A) include SUPER BECKAMINE® L-148-55, SUPER BECKAMINE® 13-535, SUPER BECKAMINE® L-145-60, and SUPER BECKAMINE® TD-126 (manufactured by DIC Corporation), and NIKALAC BL-60 and NIKALAC BX-4000 (manufactured by NipAon Carbide Industries Co., Inc.).

Further, the compound (including a multimer) represented by General Formula (A) may be dissolved in an appropriate solvent such as toluene, xylene, or ethyl acetate and washed with distilled water, ion exchange water, or the like, or treated with an ion exchange resin to be removed in order to eliminate the influence of a residual catalyst after synthesis or purchase of a commercially available product.

### Melamine Compound

It is desirable that the melamine compound is, for example, a melamine skeleton (structure) which is particularly at least one of a compound represented by General Formula (B) or a multimer thereof. Here, the multimer is an oligomer in which a compound represented by General Formula (B) is polymerized as a structural unit similar to General Formula (A), and the polymerization degree thereof is, for example, 2 or greater and 200 or less (for example, preferably 2 or greater and 100 or less). Further, the compound represented by General Formula (B) or the multimer thereof may be used alone or in combination of two or more kinds thereof. Further, the compound represented by General Formula (B) or the multimer thereof may be used in combination with the compound represented by General Formula (A) or the multimer thereof. In particular, in a case where two or more kinds of the compounds represented by General Formula (B) are mixed and used or the compound is used as a multimer (oligomer) having the compound as a structural unit, the solubility in a solvent is improved.

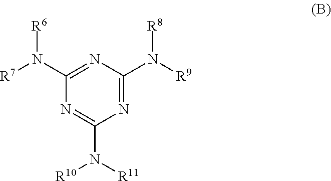

In General Formula (B), R⁶ to R¹¹ each independently represent a hydrogen atom, —CH₂—OH, —CH₂—O—R¹², or —O—R¹², and R¹² represents an alkyl group having 1 or more and 5 or less carbon atoms that may be branched. Examples of the alkyl group include a methyl group, an ethyl group, and a butyl group.

The compound represented by General Formula (B) is synthesized by a known method using, for example, melamine and formaldehyde (for example, synthesized in the same manner as the melamine resin in The fourth series of Experimental Chemistry, Vol. 28, p. 430).

Hereinafter, exemplary compounds (B)-1 to (B)-8 are shown as specific examples of the compound represented by General Formula (B), but the present exemplary embodiment is not limited thereto. Further, the following specific examples are monomers, but multimers (oligomers) having these monomers as structural units may be used.

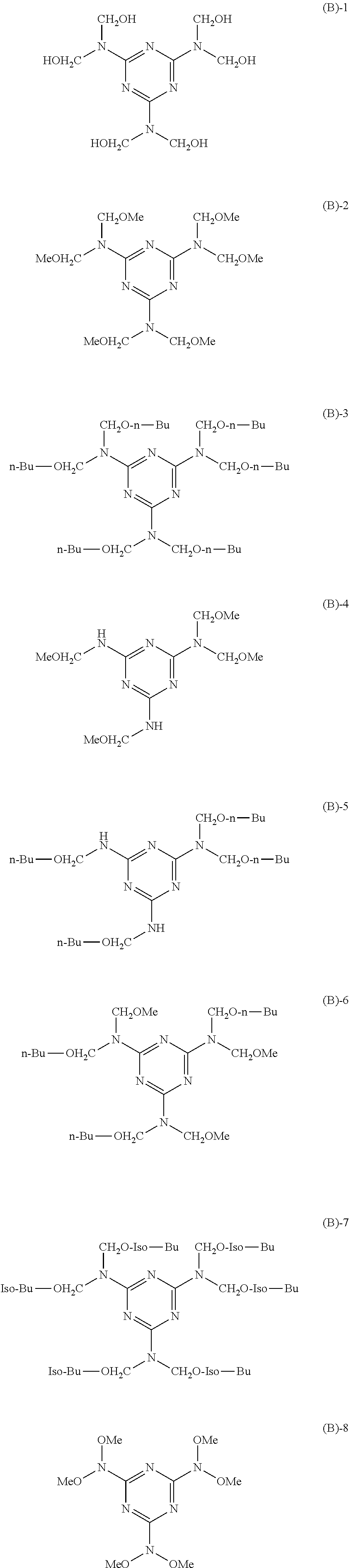

Examples of a commercially available product of the compound represented by General Formula (B) include SUPER MELAMI No. 90 (manufactured by NOF Corporation), SUPER BECKAMINE® TD-139-60 (manufactured by DIC Corporation), U-VAN 2020 (manufactured by Mitsui Chemicals, Inc.), SUMITEX RESIN M-3 (manufactured by Sumitomo Chemical Industry Co., Ltd.), and NiKALAC MfW-30 (manufactured by Nippon Carbide Industries Co., Inc.).

Further, the compound (including a multimer) represented by General Formula (B) may be dissolved in an appropriate solvent such as toluene, xylene, or ethyl acetate and washed with distilled water, ion exchange water, or the like, or treated with an ion exchange resin for removal in order to eliminate the influence of a residual catalyst after synthesis or purchase of a commercially available product.

The curing agent may further include other curing agents in addition to the guanamine compound and the melamine compound within a range where the effects of the present exemplary embodiment are exhibited. Examples of other curing agents include an isocyanate compound and a polyol.

The proportion of the guanamine compound and the melamine compound in the total amount of the curing agent is, for example, preferably 80% by mass or greater, more preferably 85% by mass or greater and 100% by mass or less, and still more preferably 90% by mass or greater and 100% by mass or less.

The surface protective layer may also contain other known additives. Examples of the additive include an antioxidant and a curing catalyst.

It is desirable that the surface protective layer contains, for example, an antioxidant as the additive. In a case where the life of the electrophotographic photoreceptor is extended by increasing the mechanical strength of the surface of the electrophotographic photoreceptor, the electrophotographic photoreceptor comes into contact with oxidizing gas for a long period of time and thus has higher oxidation resistance than the related art. From this viewpoint, in a case where the electrophotographic photoreceptor contains an antioxidant, deterioration due to the oxidizing gas such as ozone generated from a charging device is likely to be prevented.

For example, a hindered phenol-based antioxidant or a hindered amine-based antioxidant is desirable as the antioxidant, and examples thereof include known antioxidants such as an organic sulfur-based antioxidant, a phosphite-based antioxidant, a dithiocarbamate-based antioxidant, a thiourea-based antioxidant, and a benzimidazole-based antioxidant. The amount of the antioxidant to be added is, for example, desirably 20% by mass or less and more desirably 10% by mass or less.

The surface protective layer may contain, for example, a curing catalyst as the additive.

For example, an acid-based curing catalyst is desirable as the curing catalyst. Examples of the acid-based catalyst include aliphatic carboxylic acid such as acetic acid, chloroacetic acid, trichloroacetic acid, trifluoroacetic acid, oxalic acid, maleic acid, malonic acid, or lactic acid, aromatic carboxylic acid such as benzoic acid, phthalic acid, terephthalic acid, or trimellitic acid and aliphatic or aromatic sulfonic acid such as methanesulfonic acid, dodecylsulfonic acid, benzenesulfonic acid, dodecylbenzenesulfonic acid, or naphthalenesulfonic acid.

The formation of the surface protective layer is not particularly limited, and a known forming method is used. For example, a coating film of a coating solution for forming a surface protective layer in which the above-described components are added to a solvent is formed, and the coating film is dried and, as necessary, subjected to a curing treatment such as heating.

Examples of the solvent for preparing the coating solution for forming a surface protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof.

In addition, the coating solution for forming a surface protective layer may be a solvent-less coating solution.

Examples of the method of coating the photosensitive layer (such as the charge transport layer) with the coating solution for forming a surface protective layer include typical methods such as a dip coating method, a push-up coating method, a wire bar coating method, a spray coating method, a blade coating method, an air knife coating method, and a curtain coating method.

Since the coating solution for forming a surface protective layer according to the present exemplary embodiment contains a reactive group with high polarity, in a case where a photosensitive layer (for example, a charge transport layer) is coated with the coating solution, the surface tension is high, and thus aggregation is easily carried out and coating film unevenness is easily caused. Therefore, for the purpose of decreasing the surface tension, typically a small amount of a leveling agent such as a fluorine compound or a silicone compound may be added to the coating solution to improve the coating properties. In this manner, since a leveling agent having a low surface tension due to the volatilization of the solvent after the coating moves (bleeds) to the vicinity of the surface, the surface of the coating film is likely to be maintained more uniformly.

The film thickness of the surface protective layer is, for example, preferably 1 μm or greater and 20 μm or less and more preferably 2 μm or greater and 10 μm or less.

### Image Forming Apparatus and Process Cartridge

An image forming apparatus according to the present exemplary embodiment includes the electrophotographic photoreceptor, a charging unit that charges a surface of the electrophotographic photoreceptor, an electrostatic latent image forming unit that forms an electrostatic latent image on the charged surface of the electrophotographic photoreceptor, a developing unit that develops the electrostatic latent image formed on the surface of the electrophotographic photoreceptor with a developer containing a toner to form a toner image, and a transfer unit that transfers the toner image to a surface of a recording medium. Further, the electrophotographic photoreceptor according to the present exemplary embodiment is employed as the electrophotographic photoreceptor.

As the image forming apparatus according to the present exemplary embodiment, known image forming apparatuses such as an apparatus including fixing means that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including cleaning means that cleans the surface of the electrophotographic photoreceptor after the transfer of the toner image and before the charging; an apparatus including charge erasing means that erases the charges on the surface of the electrophotographic photoreceptor by applying the charge erasing light after the transfer of the toner image and before the charging; and an apparatus including an electrophotographic photoreceptor heating member for increasing the temperature of the electrophotographic photoreceptor and decreasing the relative temperature are employed.

In a case of the intermediate transfer type apparatus, the transfer unit is, for example, configured to include an intermediate transfer member having a surface onto which the toner image is transferred, a primary transfer unit primarily transferring the toner image formed on the surface of the electrophotographic photoreceptor to the surface of the intermediate transfer member, and a secondary transfer unit secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging unit, an electrostatic latent image forming unit, a developing unit, and a transfer unit in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

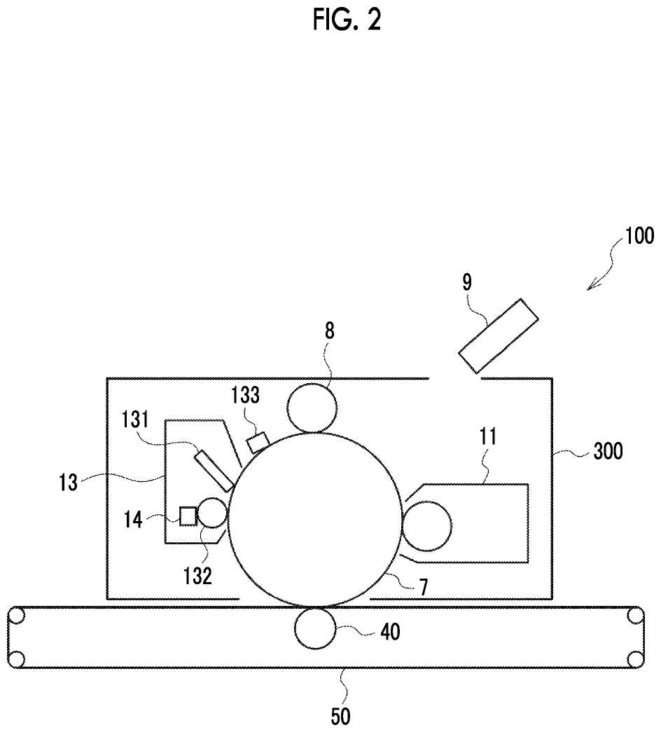

FIG. 2 is a schematic configuration view showing an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of an electrostatic latent image forming unit), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer unit.

The process cartridge 300 in FIG. 2 integrally supports the electrophotographic photoreceptor 7, a charging device 8 (an example of the charging unit), a developing device 11 (an example of the developing unit), and a cleaning device 13 (an example of the cleaning unit) in a housing. The cleaning device 13 has a cleaning blade (an example of the cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, for example, a contact type charger formed of a conductive or semi-conductive charging roller, a charging brush, a charging film, a charging rubber blade, a charging tube, or the like is used. Further, a known charger such as a non-contact type roller charger, or a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used. In addition to the cleaning blade type device, a fur brush cleaning type device or a simultaneous development cleaning type device may be employed.

### Transfer Device

Examples of the transfer device 40 include a known transfer charger such as a contact type transfer charger using a belt, a roller, a film, a rubber blade, or the like, or a scorotron transfer charger or a corotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

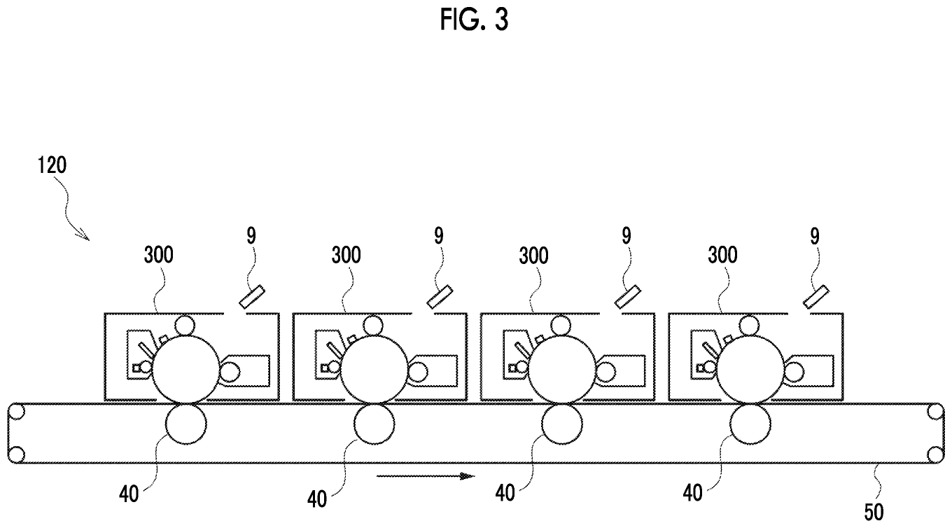

FIG. 3 is a schematic configuration view showing another example of the image forming apparatus according to the present exemplary embodiment.

An image forming apparatus 120 shown in FIG. 3 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### EXAMPLES

Hereinafter, exemplary embodiments of the invention will be described in detail based on examples, but the exemplary embodiments of the invention are not limited to the examples. In the following description, “parts” and “%” are on a mass basis unless otherwise specified.

In the following description, the synthesis, the treatment, the production, and the like are carried out at room temperature (25° C.±3° C.) unless otherwise specified.

### Production of Polyester Resin (1)

### Polyester Resin (1-1)

12.6373 g of 4,4′-(4-methylpentane-2,2,diyl)diphenol, 0.1233 g of 4-t butylphenol, 0.0632 g of sodium hydrosulfite, and 240 mL of water are added to a reaction container equipped with a stirrer to prepare a suspension. 4.8392 g of sodium hydroxide, 0.1981 g of benzyltributylammonium chloride, and 160 mL of water are added to the suspension while being stirred at a temperature of 20° C., and the mixture is stirred for 30 minutes in a nitrogen atmosphere. 220 mL of o-dichlorobenzene is added to the aqueous solution, the solution is stirred for 30 minutes in a nitrogen atmosphere, and 12.0000 g of 4,4′-biphenyldicarbonyl chloride is added thereto in a state of powder. After completion of the addition, the reaction is allowed to proceed by stirring the solution at a temperature of 20° C. for 4 hours in a nitrogen atmosphere. The polymerized solution is diluted with 300 mL of o-dichlorobenzene to remove the aqueous layer. After the solution is washed with a dilute acetic acid solution and ion exchange water, the solution is poured into methanol to precipitate the polymer. The precipitated polymer is separated by filtration and dried at 50° C. The polymer is redissolved in 900 mL of tetrahydrofuran, and the mixture is poured into methanol to precipitate the polymer. The precipitated polymer is separated by filtration, washed with methanol, and dried at 50° C., thereby obtaining 17.5 g of a white polymer.

The weight-average molecular weight obtained by using gel permeation chromatography (GPC) is 105,000. The measurement is performed by using tetrahydrofuran as an eluent, and the molecular weight of the polymer is determined as the molecular weight in terms of polystyrene.

### Polyester Resins (1-2) to (1-8)

Each of polyester resins is synthesized in the same manner as in the step of producing the polyester resin (1-1) except that the kind of monomer used is changed. The kind of monomer of the polyester resin is listed in Table 1.

### Example 1

### Formation of Undercoat Layer

A cylindrical aluminum tube having an outer diameter of 30 mm, a length of 250 mm, and a thickness of 1 mm is prepared as a conductive substrate.

100 parts of zinc oxide (average particle diameter of 70 nm, specific surface area of 15 m²/g, manufactured by Tayca Corporation) is stirred and mixed with 500 parts of toluene, 1.3 parts of a silane coupling agent (trade name: KBM603, manufactured by Shin-Etsu Chemical Co., Ltd., N-2-(aminoethyl)-3-aminopropyltrimethoxysilane) is added thereto, and the mixture is stirred for 2 hours. Thereafter, toluene is distilled off under reduced pressure and baked at 120° C. for 3 hours to obtain zinc oxide subjected to a surface treatment with a silane coupling agent.

110 parts of the surface-treated zinc oxide is stirred and mixed with 500 parts of tetrahydrofuran, a solution obtained by dissolving 0.6 parts of alizarin in 50 parts of tetrahydrofuran is added thereto, and the mixture is stirred at 50° C. for 5 hours. Thereafter, the solid content is separated by filtration by carrying out filtration under reduced pressure and dried at 60° C. under reduced pressure, thereby obtaining zinc oxide with alizarin.

100 parts of a solution obtained by dissolving 60 parts of the zinc oxide with alizarin, 13.5 parts of a curing agent (blocked isocyanate, trade name: SUMIDUR 3175, manufactured by Sumitomo Bayer Urethane Co., Ltd.), and 15 parts of a butyral resin (trade name: S-LEC BM-1, manufactured by Sekisui Chemical Co., Ltd.) in 68 parts of methyl ethyl ketone is mixed with 5 parts of methyl ethyl ketone, and the solution is dispersed in a sand mill for 2 hours using 1 mmφ glass beads, thereby obtaining a dispersion liquid. 0.005 parts of dioctyltin dilaurate as a catalyst and 4 parts of silicone resin particles (trade name: TOSPEARL 145, manufactured by Momentive Performance Materials Inc.) are added to the dispersion liquid, thereby obtaining a coating solution for forming an undercoat layer. The outer peripheral surface of the conductive substrate is coated with the coating solution for forming an undercoat layer by a dip coating method, and dried and cured at 170° C. for 40 minutes to form an undercoat layer. The average thickness of the undercoat layer is 25 m.

### Formation of Charge Generation Layer

A mixture of 15 parts of hydroxygallium phthalocyanine as a charge generation material (having diffraction peaks at positions where Bragg angles (2θ±0.2°) in the X-ray diffraction spectrum using Cuka characteristic X-rays are at least of 7.5°, 9.9°, 12.5°, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads having a diameter of 1 mm. 175 parts of n-butyl acetate and 180 parts of methyl ethyl ketone are added to the dispersion liquid, and the mixture is stirred, thereby obtaining a coating solution for forming a charge generation layer. The undercoat layer is dipped in and coated with the coating solution for forming a charge generation layer, and dried at room temperature (25° C. 3C) to form a charge generation layer having an average thickness of 0.18 μm.

### Formation of Charge Transport Layer

5 parts of the polyester resin (1-1) as a binder resin and 40 parts of HTM-1 as a charge transport material are dissolved in 270 parts of tetrahydrofuran and 30 parts of toluene, thereby obtaining a coating solution for forming a charge transport layer. The charge generation layer is dipped in and coated with the coating solution for forming a charge transport layer, and dried at 145° C. for 30 minutes to form a charge transport layer. The average thickness of the charge transport layer is 24 m.

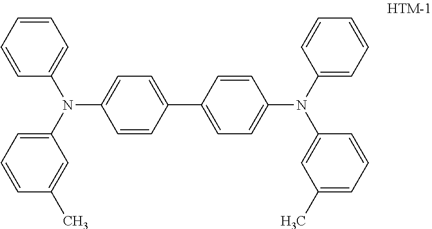 [SMILES: Cc1cccc(N(c2ccccc2)c2ccc(-c3ccc(N(c4ccccc4)c4cccc(C)c4)cc3)cc2)c1]

### Formation of Surface Protective Layer

parts by mass of a charge transport material (I-25), 10 parts by mass of a charge transport material (I-8), 2 parts by mass of a charge transport material (I-26), 1 part by mass of a charge transport material (I-27), and 0.5 parts by mass of methoxymethylated melamine ((B)-2) are added to a mixed solvent of 35 parts by mass of isopropanol and 20 parts by mass of n-butanol and stirred and dissolved at 50° C. for 2 hours. Next, the solution is naturally cooled to room temperature, and 0.1 parts by mass of Nacure 2500 (manufactured by King Industries, Inc.) is added to the solution as the curing catalyst, thereby obtaining a coating solution for forming a surface protective layer. The charge transport layer is dipped in and coated with the coating solution for forming a surface protective layer, touch-dried at 25° C. for 10 minutes, and dried and cured at 150° C. for 60 minutes, thereby obtaining an electrophotographic photoreceptor.

### Examples 2 to 17

Each of photoreceptors is prepared in the same manner as in Example 1 except that the kind and the amount of the polyester resin (1-1) and the curing agent of the surface protective layer are changed to the specifications listed in Table 1 in the formation of the charge transport layer.

### Comparative Examples 1 and 2

Each of photoreceptors is prepared in the same manner as in Example 1 except that the resin listed in the table 1 is used in place of the polyester resin (1-1) in the formation of the charge transport layer. Further, the details of the resin used in place of the polyester resin are as follows.

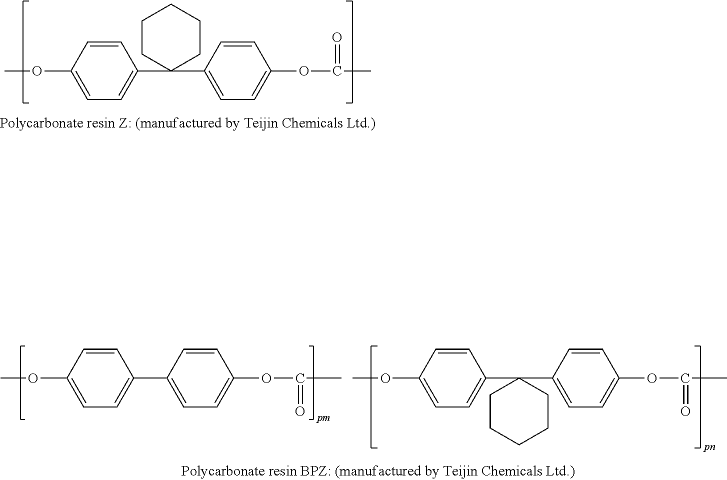

### Comparative Example 3

A photoreceptor is prepared in the same manner as in Example 2 except that “phenol resin PL-2243 (manufactured by Gun Ei Chemical Industry Co., Ltd.) is used in place of “methoxymethylated melamine (B)-2” as the curing agent in the formation of the surface protective layer.

### Evaluation

The electrophotographic photoreceptors of each example are mounted on an image forming apparatus Color 1000i Press (manufactured by FUJIFILM Business Innovation Corporation), and the following evaluation is performed using this image forming apparatus.

### Image Quality Evaluation

A test of outputting images 20% halftone images on 100,000 sheets is performed in an environment of a temperature of 28° C. and a relative humidity of 85%. Thereafter, the obtained image quality of the 100,000th sheet is evaluated according to the following evaluation standards. Further, the present evaluation is the evaluation performed in a state where the film thickness of the surface protective layer provided on the electrophotographic photoreceptor of each example is set to 2 μm, which is thin, in an environment in which the surface protective layer is likely to be peeled off or floated. The results are shown in the following table.
A: Density unevenness is not found, which is not problematic.
B: Density unevenness occurs in an acceptable level for practical use.
C: Streak-like density unevenness occurs due to peeling in a problematic level for practical use.

### Evaluation of Adhesiveness

The surface of the photoreceptor after completion of the image quality evaluation is visually observed, and the peeling and floating of the surface protective layer of the electrophotographic photoreceptor are evaluated according to the following evaluation standards. The results are shown in the following table.
A: Peeling is not found, which is not problematic.
B: Slight partial discoloration is visually observed, but peeling is not observed in an acceptable level.
C: Streak-like peeling is visually observed in a problematic level.

TABLE 1

| | Charge transport layer | | | | | | | | | | |
|---|---|---|---|---|---|---|---|---|---|---|---|
| | Polyester resin (1) or comparative | | | | | | | | | | |
| | polyester resin | | | | | | | | | | |
| | | | | Content | | | | | | | |
| | | | | with | | | | | | | |
| | | | | respect to | | | | | | | |
| | | | | total solid | | | Surface free energy | | | Evaluation of | |
| | | | | content of | | | Surface | Charge | Charge | performance of | |
| | | Dicarboxylic | Diol | charge | | | protective | transport | transport | photoreceptor | |
| | | acid unit | unit | transport | Surface protective layer | | layer | layer | layer | | Image |
| | Resin | Unit (A) | Unit (B) | layer | Curing agent | | E_{OCL} | E_{CT} | E_{OCL} − E_{CT} | Adhesive- | quality |
| | No. | Type | Type | mass % | Type | Amount | mN/m | mN/m | mN/m | ness | evaluation |
| Comparative | C1 | Polycarbonate resin | | 58 | Melamine | 0.5 parts | 41 | 30.5 | 10.5 | C | C |
| Example 1 | | Z | | | compound (B)-2 | by mass | | | | | |
| Comparative | C2 | Polycarbonate resin | | 58 | Melamine | 0.5 parts | 41 | 31 | 10 | B | C |
| Example 2 | | BPZ | | | compound (B)-2 | by mass | | | | | |
| Comparative | C3 | A-1 | B-19 | 58 | Phenol resin | 0.5 parts | 45 | 32.5 | 12.5 | C | C |
| Example 3 | | | | | PL-2243 | by mass | | | | | |
| Example 1 | 1-1 | A-12 | B-19 | 58 | Melamine | 0.5 parts | 41 | 32.5 | 8.50 | A | A |
| | | | | | compound (B)-2 | by mass | | | | | |
| Example 2 | 1-2 | A-1 | B-19 | 58 | Melamine | 0.5 parts | 41 | 32.5 | 8.50 | A | A |
| | | | | | compound (B)-2 | by mass | | | | | |
| Example 3 | 1-3 | A-1, C-1 | B-10 | 58 | Melamine | 0.5 parts | 41 | 34.5 | 6.50 | A | A |
| | | (molar ratio | | | compound (B)-2 | by mass | | | | | |
| | | 1:1) | | | | | | | | | |
| Example 4 | 1-4 | A-10 | B-31 | 58 | Melamine | 0.5 parts | 41 | 34.0 | 7.00 | A | A |
| | | | | | compound (B)-2 | by mass | | | | | |
| Example 5 | 1-5 | A-1, A-7 | B-17 | 58 | Melamine | 0.5 parts | 41 | 33.0 | 8.00 | A | A |
| | | (molar ratio | | | compound (B)-2 | by mass | | | | | |
| | | 1:1) | | | | | | | | | |
| Example 6 | 1-6 | A-12 | B-10 | 58 | Melamine | 0.5 parts | 41 | 32.5 | 8.50 | A | A |
| | | | | | compound (B)-2 | by mass | | | | | |
| Example 7 | 1-7 | A-4 | B-19 | 58 | Melamine | 0.5 parts | 41 | 32.2 | 8.80 | B | A |
| | | | | | compound (B)-2 | by mass | | | | | |
| Example 8 | 1-8 | A-7 | B-19 | 58 | Melamine | 0.5 parts | 41 | 32.0 | 9.00 | B | A |
| | | | | | compound (B)-2 | by mass | | | | | |
| Example 9 | 1-1 | A-12 | B-19 | 58 | Melamine | 0.5 parts | 43 | 32.5 | 10.50 | B | B |
| | | | | | compound (B)-1 | by mass | | | | | |
| Example 10 | 1-1 | A-12 | B-19 | 58 | Melamine | 0.5 parts | 37 | 32.5 | 4.50 | B | B |
| | | | | | compound (B)-3 | by mass | | | | | |
| Example 11 | 1-1 | A-12 | B-19 | 63 | Melamine | 1.0 parts | 42 | 34 | 8.00 | B | A |
| | | | | | compound (B)-2 | by mass | | | | | |
| Example 12 | 1-1 | A-12 | B-19 | 55 | Melamine | 0.5 parts | 41 | 31.5 | 9.50 | B | B |
| | | | | | compound (B)-2 | by mass | | | | | |
| Example 13 | 1-1 | A-12 | B-19 | 55 | Melamine | 0.3 parts | 42 | 32 | 10 | B | B |
| | | | | | compound (B)-1 | by mass | | | | | |
| Example 14 | 1-1 | A-12 | B-19 | 60 | Melamine | 0.5 parts | 41 | 33 | 8 | B | B |
| | | | | | compound (B)-2 | by mass | | | | | |
| Example 15 | 1-1 | A-12 | B-19 | 58 | Benzoguanamine | 0.5 parts | 40 | 32.5 | 7.50 | A | A |
| | | | | | resin (A)-14 | by mass | | | | | |
| Example 16 | 1-1 | A-12 | B-19 | 65 | Melamine | 0.5 parts | 41 | 34.5 | 6.5 | B | B |
| | | | | | compound (B)-2 | by mass | | | | | |
| Example 17 | 1-1 | A-12 | B-19 | 35 | Melamine | 0.5 parts | 41 | 30 | 11 | B | B |
| | | | | | compound (B)-2 | by mass | | | | | |

As listed in Table 1, it is found that the electrophotographic photoreceptors of the examples suppress the surface protective layer from being peeled off or being floated from the charge transport layer even in a case where the thickness of the surface protective layer is 2 m, which is thin, as compared with the electrophotographic photoreceptors of the comparative examples.

Specific means for addressing the above-described problems includes the following aspects.
(((1))) An electrophotographic photoreceptor comprising:
a conductive substrate;
an undercoat layer that is provided on the conductive substrate;
a charge generation layer that is provided on the undercoat layer;
a charge transport layer that is provided on the charge generation layer and contains a polyester resin (1) having a dicarboxylic acid unit (A) represented by Formula (A) and a diol unit (B) represented by Formula (B) and a charge transport material; and
a surface protective layer that is provided on the charge transport layer and is a cured film with a composition containing a curing agent which contains at least one of a guanamine compound or a melamine compound, and at least one reactive group-containing charge transport material having at least one substituent selected from the group consisting of —OH, —OCH₃, —NH₂, —SH, and —COOH,

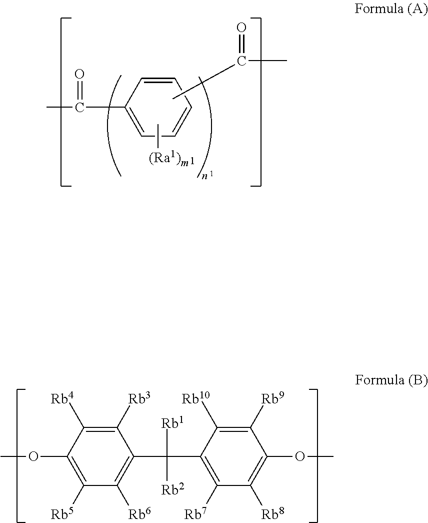

in Formula (A), n¹ represents 1, 2, or 3, n¹ pieces of m¹'s each independently represent 0, 1, 2, 3, or 4, m¹ pieces of Ra¹'s each independently represent an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.
(((2))) An electrophotographic photoreceptor according to (((1))),
wherein a difference (E_{OCL}−E_{CT}) between a surface free energy E_{OCL} in the surface protective layer and a surface free energy E_{CT} in the charge transport layer is 6 mN/m or greater and 10 mN/m or less.
(((3))) The electrophotographic photoreceptor according to (((2))),
wherein the surface protective layer has a surface free energy E_{OCL} of 38 mN/m or greater and 42 mN/m or less.
(((4))) The electrophotographic photoreceptor according to (((2))) or (((3))),
wherein the charge transport layer has a surface free energy E_{CT} of 32 mN/m or greater and 35 mN/m or less.
(((5))) The electrophotographic photoreceptor according to any one of (((1))) to
(((4))),
wherein the reactive group-containing charge transport material has at least one substituent of —OH or —OCH₃ as the substituent.
(((6))) The electrophotographic photoreceptor according to any one of (((1))) to (((5))),
wherein a content of the polyester resin (1) is 35% by mass or greater and 65% by mass or less with respect to a total solid content of the charge transport layer.
(((7))) A process cartridge comprising:
the electrophotographic photoreceptor according to any one of (((1))) to (((6))),
wherein the process cartridge is attachable to and detachable from an image forming apparatus.
(((8))) An image forming apparatus comprising:
the electrophotographic photoreceptor according to any one of (((1))) to (((6)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
an undercoat layer that is provided on the conductive substrate;
a charge generation layer that is provided on the undercoat layer;
a charge transport layer that is provided on the charge generation layer and contains a polyester resin (1) having a dicarboxylic acid unit (A) represented by Formula (A) and a diol unit (B) represented by Formula (B) and a charge transport material; and
a surface protective layer that is provided on the charge transport layer and is a cured film with a composition containing a curing agent which contains at least one of a guanamine compound or a melamine compound, and at least one reactive group-containing charge transport material having at least one substituent selected from the group consisting of —OH, —OCH₃, —NH₂, —SH, and —COOH, 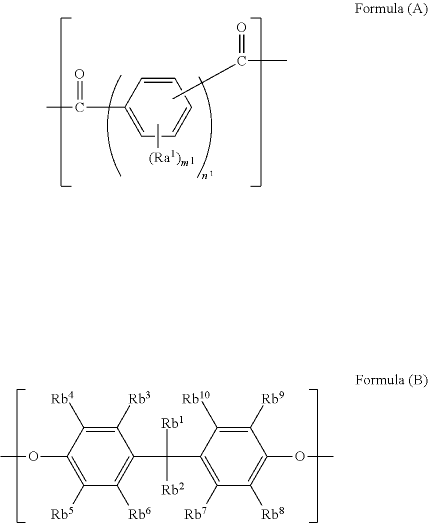
in Formula (A), n¹ represents 1, 2, or 3, n¹ pieces of m¹'s each independently represent 0, 1, 2, 3, or 4, m¹ pieces of Ra¹'s each independently represent an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ each independently represent a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

2. An electrophotographic photoreceptor according to claim 1,
wherein a difference (E_{OCL}−E_{CT}) between a surface free energy E_{OCL} in the surface protective layer and a surface free energy E_{CT} in the charge transport layer is 6 mN/m or greater and 10 mN/m or less.

3. The electrophotographic photoreceptor according to claim 2,
wherein the surface protective layer has a surface free energy E_{OCL} of 38 mN/m or greater and 42 mN/m or less.

4. The electrophotographic photoreceptor according to claim 2,
wherein the charge transport layer has a surface free energy E_{CT} of 32 mN/m or greater and 35 mN/m or less.

5. The electrophotographic photoreceptor according to claim 1,
wherein the reactive group-containing charge transport material has at least one substituent of —OH or —OCH₃ as the substituent.

6. The electrophotographic photoreceptor according to claim 1,
wherein a content of the polyester resin (1) is 35% by mass or greater and 65% by mass or less with respect to a total solid content of the charge transport layer.

7. A process cartridge comprising:
the electrophotographic photoreceptor according to claim 1,
wherein the process cartridge is attachable to and detachable from an image forming apparatus.

8. A process cartridge comprising:
the electrophotographic photoreceptor according to claim 2,
wherein the process cartridge is attachable to and detachable from an image forming apparatus.

9. A process cartridge comprising:
the electrophotographic photoreceptor according to claim 3,
wherein the process cartridge is attachable to and detachable from an image forming apparatus.

10. A process cartridge comprising:
the electrophotographic photoreceptor according to claim 4,
wherein the process cartridge is attachable to and detachable from an image forming apparatus.

11. A process cartridge comprising:
the electrophotographic photoreceptor according to claim 5,
wherein the process cartridge is attachable to and detachable from an image forming apparatus.

12. A process cartridge comprising:
the electrophotographic photoreceptor according to claim 6,
wherein the process cartridge is attachable to and detachable from an image forming apparatus.

13. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

14. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

15. An image forming apparatus comprising:
the electrophotographic photoreceptor according to claim 3;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

16. An image forming apparatus comprising:
the electrophotographic photoreceptor according to claim 4;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

17. An image forming apparatus comprising:
the electrophotographic photoreceptor according to claim 5;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

18. An image forming apparatus comprising:
the electrophotographic photoreceptor according to claim 6;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
